(19) United States
(12) Patent Application Publication
(10) Pub. No.: US 2025/0369692 A1
(43) Pub. Date: Dec. 4, 2025

(54) APPARATUS AND METHOD TO CURE A COATING ON A METALLIC CONTAINER

(71) Applicant: Ball Corporation, Westminster, CO (US)

(72) Inventors: Julian Stock, Denver, CO (US); John D. Efner, Surprise, AZ (US)

(73) Assignee: Ball Corporation, Westminser, CO (US)

(21) Appl. No.: 19/220,492

(22) Filed: May 28, 2025

Related U.S. Application Data
(60) Provisional application No. 63/653,425, filed on May 30, 2024.

(51) Int. Cl. F26B 23/04

(52) U.S. Cl. CPC F26B 23/04

(57) ABSTRACT

Apparatus and methods of heating metallic containers in an oven which includes electric heater housings are provided. The electric heater housings include an electric induction element. The electric heater housings heat the metallic containers to a predetermined temperature to dry moisture on the metallic containers or to cure inks and coatings. Air within the oven may be at a temperature that is less than the predetermined temperature.

### CROSS-REFERENCE TO RELATED APPLICATIONS

This application claims priority under 35 U.S.C. § 119(e) to U.S. Provisional Application No. 63/653,425, filed on May 30, 2024, which is incorporated herein in its entirety by reference.

### FIELD

The present disclosure generally relates to the treatment of metallic containers and other metallic workpieces. More specifically, the present disclosure provides apparatus and methods of heating metallic containers and other metallic workpieces to dry or to cure inks and coatings applied to interior surfaces of the metallic containers and other metallic workpieces.

### BACKGROUND

Metallic containers offer distributors and consumers many benefits. The body of a metallic container provides enhanced protection properties for beverages and foodstuffs. The surfaces of metallic containers are also ideal for decorating with brand names, logos, designs, product information, and/or other preferred indicia for identifying, marketing, and distinguishing the metallic container and its contents from other products and competitors. Thus, metallic containers offer bottlers, distributors, and retailers an ability to stand out at the point of sale.

Additionally, many consumers prefer metallic containers compared to containers made of glass or plastic. Metallic containers are particularly attractive to consumers because they are recyclable, lightweight, and efficient. Metallic containers are suitable for use in public places and outdoors because they are more durable than glass containers. Further, some consumers avoid plastic containers due to concerns that the plastic may leach chemicals into consumable products.

As a result of these and other benefits, sales of metallic containers were valued at approximately $53 billion globally in 2014. A large percentage of the metallic container market is driven by beverage containers. According to one report, approximately 290 billion metallic beverage containers were shipped globally in 2012. One U.S. trade group reported that 126 billion metallic containers were shipped in the U.S. alone in 2014. To meet this demand, metallic container manufacturing facilities operate some of the fastest and most efficient production lines in the container industry. For example, one facility in Colorado manufactures about 6,000,000 metallic containers per day. Accordingly, specialized equipment is required for many of the high-speed operations performed to form the metallic containers.

Metallic containers are frequently produced by a draw and wall ironing (DWI) process. Production lines generally include a cupper that cuts circular blanks from an aluminum sheet and forms the blanks into cups. Bodymakers use a punch on a ram to push the cups through a series of tooling dies that redraw and iron the cups into container bodies. The open ends of the container bodies are then cut to a uniform height by trimmers. The container bodies are then washed. A first oven, known as a “dry-off oven”, then dries the container bodies.

Some container bodies then receive an exterior basecoat. The basecoat is sometimes required to provide a base color before subsequent decorations or coatings are applied. The container bodies are then conveyed through a second oven or “basecoat oven” where the basecoat is cured.

The exterior sidewalls of the container bodies are decorated with six or more colors of ink by a decorator. The decorator also applies a film of lacquer over the entire decoration to protect it. A bottom coater applies a coating of lacquer to the rim around the bottom of the container bodies.

The inks and lacquer coatings of the container bodies are then cured by a third oven known as a “deco oven”. The deco oven is also known as a “pin oven” because container bodies are typically transported through the oven on a chain with pins. The pins are placed into the open ends of the container bodies to transport them without touching the exterior surfaces of the container bodies.

After the decoration and other exterior coatings are at least partially cured, the container bodies receive an internal coating, such as a lacquer, to protect product integrity. The internal coating is subsequently cured as the container bodies pass through a fourth oven known as an “internal coater oven” or “internal bake oven” (IBO).

The open ends of the container bodies then receive a thin coat of a lubricant from a waxer in preparation for necking. A die necker then squeezes the open ends down to a predetermined diameter. Next, the open ends are rolled back to form a lip or flange, which is used to attach an end closure after the container body is filled with a product.

A dome at the closed end of the container bodies may then be reprofiled for stackability. Optionally, an inner portion of the dome may be reformed to improve strength. The container bodies are then tested, inspected, and placed in pallets.

The ovens typically burn fossil fuels, such as natural gas or propane, to produce the hot air used to dry moisture on the container bodies or to cure inks and coatings. Substantial amounts of fossil fuels are used by the ovens. One known pin oven uses about 1,000 standard cubic feet per hour (SCFH) of natural gas or about 400 SCFH of propane. As will be appreciated by one of ordinary skill in the art, the use of fossil fuels to heat the air for the ovens creates a large amount of CO₂ emissions.

Handling waste heat that radiates from a conventional gas fired oven is a considerable problem. As will be appreciated by one of ordinary skill in the art, cooling the metallic container manufacturing facility requires a significant amount of energy. The cooling system must be sized to handle the heat radiated from the conventional oven, increasing the costs of operating the metallic container manufacturing facility.

Another problem with a prior art oven that uses hot air is the damage to container bodies that occurs when the production line stops. Conventional ovens that are heated with fossil fuels are not structured to quickly cool down or heat up. Accordingly, conventional ovens operate substantially continuously and are typically left on even when the production line stops to prevent temperatures in the ovens from falling below an operating temperature. Container bodies within an oven during a production line stoppage will be exposed to hot air for longer than intended. While the production line is stopped, the container bodies in the oven will be continuously heated by the hot air. This may damage the mobility enhancers, coatings, and ink on the container bodies if the production line is stopped for too long, creating a substantial number of waste container bodies.

A prior art oven also has a complex ventilation system to circulate the hot air within the oven. The air within the oven must be kept at a high temperature to dry or cure coatings on the container bodies. The ventilation system includes a large amount of ducting to move the hot air from gas burners to the container bodies. Fans or blowers of the ventilation system must have the capacity to move a large volume of air. The ventilation system contributes to the large size of the prior art oven, which requires a substantial amount of valuable space on the product floor of the metallic container manufacturing facility.

Another problem with prior art pin ovens that use fossil fuels is that the pin chain is heated to the temperature within the pin oven (which may be approximately 425° F.) as the pin chain transports the container bodies through the pin oven. The pin chain subsequently cools down to room or ambient temperature (approximately 75° F.) after the pin chain exits the pin oven to transport the container bodies to downstream equipment. The pin chain then returns to the decorator to pick up more container bodies, which it transports into the pin oven again. The pin chain may cycle through the pin oven over 1,000 times per day. As the pin chain repeatedly heats and cools while in use, the repeated thermal cycling causes substantial wear to the pin chain and loss of lubrication on the pin chain.

Accordingly, there is a need for apparatus and methods of heating container bodies that do not use fossil fuels to generate hot air to heat the container bodies, which reduces the amount of CO₂ emissions, that do not expose the container bodies to excessive heat when the production line stops, which require less floor space than a prior art oven, and which do not subject the pin chain to frequent thermal cycling.

### SUMMARY

One aspect of the present disclosure is a pin oven that uses electric induction elements that can quickly heat a metallic container soon after being turned on. In contrast, a prior art oven that uses hot air to heat container bodies requires a greater amount of energy to heat the air in the oven and to maintain the air at a temperature required to cure a coating on the container bodies.

A first aspect of the present disclosure is to provide an oven for one or more of curing a coating on a surface of a metallic workpiece and drying the surface of the metallic workpiece, the oven comprising: (1) a heater housing, comprising: (a) a first end; and (b) a second end spaced from the first end; (2) a tunnel extending through the heater housing from the first end to the second end, the tunnel comprising: (a) an entrance at the first end; (b) an exit at the second end; (c) a wall extending from the first end to the second end, the wall defining a periphery of the tunnel, the periphery having a geometry to receive the metallic container body; and (d) a slot extending through the wall, the slot extending from the entrance to the exit; (3) an induction element within the heater housing in an enclosed area between exterior surfaces of the heater housing and the periphery of the tunnel, the induction element operable to heat the metallic workpiece; (4) a pin chain extending through the oven, a portion of the wall of the tunnel being positioned proximate to a portion of the pin chain with the pin chain positioned outside of the tunnel, the pin chain comprising a pin configured to engage the metallic workpiece, the pin extendable through the slot to transport the metallic workpiece through the tunnel; and (5) a ventilation system operable to selectively remove air from the tunnel.

In at least one embodiment, the pin is configured to engage an interior surface of the metallic workpiece.

In some embodiments, the pin is configured to rotate around its longitudinal axis such that the metallic workpiece rotates as the metallic workpiece moves through the tunnel.

The oven of the first aspect optionally includes one or more of the previous embodiments, and the induction element may comprise an inductor to create an electromagnetic field and produce an eddy current in the metallic workpiece.

The oven of the first aspect optionally includes one or more of the previous embodiments, and optionally further comprises a cooling element to adjust a temperature of the induction element.

In some embodiments, the cooling element comprises a fluid.

In at least one embodiment, the fluid comprises water.

The oven of the first aspect optionally includes one or more of the previous embodiments, and, optionally, the cooling element may comprise a tube that extends proximate to at least a portion of the induction element.

In some embodiments, the tube extends through at least a portion of the induction element.

Additionally, or alternatively, the cooling element is optionally configured to maintain the induction element within a predetermined operating temperature during operation of the oven.

In at least one embodiment, the predetermined operating temperature is between about 60° F. and about 115° F.

The oven of the first aspect optionally includes one or more of the previous embodiments, and in some further embodiments, the heater housing is a first heater housing configured to heat the metallic workpiece to a first temperature. In these further embodiments, the tunnel extends through a second heater housing downstream from the first heater housing, the second heater housing comprising a second induction element configured to heat the metallic workpiece to a second temperature that is greater than the first temperature.

The oven of the first aspect optionally includes one or more of the previous embodiments, and may further comprise the pin being configured to transport the metallic workpiece through the tunnel such that an exterior surface of the metallic workpiece does not contact the tunnel.

The oven of the first aspect may comprise any one or more of the previous embodiments, and further comprises the heater housing being configured such that the pin can transport the metallic container body through the tunnel during operation of the oven such that the exterior surface of the metallic container body does not contact the tunnel.

The oven of the first aspect optionally includes one or more of the previous embodiments, and may further comprise a duct and a first port to draw air with contaminates from a first portion of the tunnel, the duct and the first port being operably associated with the ventilation system.

Additionally, or alternatively, the oven of the first aspect optionally includes one or more of the previous embodiments, and the ventilation system may further comprise a second port to draw air with contaminates from a second portion of the tunnel.

In at least some embodiments, the ventilation system can selectively withdraw air from: only the first port; only the second port; and both the first and second ports.

The oven of the first aspect optionally includes one or more of the previous embodiments, and optionally the ventilation system further comprises a damper associated with the first port, the damper being adjustable from an open position to a closed position, and the damper being adjustable to a plurality of intermediate positions between the open and closed positions, such that altering a position of the damper changes a volume of air removed from the tunnel through the first port.

In at least one embodiment, the ventilation system further comprises a thermocouple to measure a temperature of air removed or withdrawn from the tunnel.

In at least some embodiments, the thermocouple is positioned in a duct of the ventilation system.

Optionally, the position of the damper is adjustable to maintain the air in the tunnel within a predetermined temperature range when the oven is in operation.

In at least one embodiment, the predetermined temperature range is from about 285° F. to about 415° F.

The oven of the first aspect optionally includes one or more of the previous embodiments, and in some embodiments, the ventilation system is operable to maintain the tunnel at less than 1 atmosphere of pressure during operation of the oven.

In at least some embodiments, an interior of the oven is at a pressure greater than the pressure within the tunnel during operation of the oven.

In one or more embodiment, the interior of the oven is at an ambient pressure during operation of the oven, and the ventilation system maintains the tunnel at less than the ambient pressure during operation of the oven.

In some embodiments, the ventilation system comprises an exhaust fan.

In some embodiments, the oven of the first aspect optionally includes one or more of the previous embodiments, and further comprises an injection port to direct air into the tunnel.

In at least one embodiment, the injection port is associated with an air source operable to heat and/or cool air.

The oven of the first aspect optionally includes one or more of the previous embodiments, and optionally a second portion of the wall is positioned between the induction element and an interior of the tunnel.

The oven of the first aspect optionally includes one or more of the previous embodiments, and optionally at least one portion of the wall is formed of a material that is non-magnetic.

In some embodiments, the material of the at least one portion of the wall is non-metallic.

Optionally, the material of the at least one portion of the wall is heat resistant.

The oven of the first aspect optionally includes one or more of the previous embodiments, and may further comprise a control system operable to send a signal to a power source associated with the induction element to adjust a heating output of the induction element.

In at least one embodiment, the control system is operable to send the signal to the power source based on one or more of: (a) a velocity of the pin chain relative to the induction element; (b) a thermal conductivity of a metallic material of the metallic workpiece; (c) a predetermined rate of heating of the metallic workpiece; (d) a temperature to which the metallic workpiece will be heated; and (e) a type of the coating on the body of the metallic container.

The oven of the first aspect optionally includes one or more of the previous embodiments, and optionally, the control system is operable to send a signal to the ventilation system to alter operation of the ventilation system to maintain the air in the tunnel within a predetermined temperature range when the oven is in operation.

In at least some embodiments, the predetermined temperature range is between about 285° F. and about 415° F.

The oven of the first aspect optionally includes one or more of the previous embodiments, and optionally, the metallic workpiece is a metallic container body.

In some embodiments, the oven of the first aspect is configured to cure (or at least partially cure) or dry the coating on an exterior surface of the metallic workpiece.

Additionally, or alternatively, in some embodiments, the oven of the first aspect is configured to cure (or at least partially cure) or dry a coating on an interior surface of the metallic workpiece.

The oven of the first aspect optionally includes one or more of the previous embodiments, and optionally the wall of the tunnel further comprises one or more of: (a) a first wall portion; (b) a second wall portion opposite to the first wall portion; (c) a third wall portion extending from the first wall portion to the second wall portion; and (d) a fourth wall portion opposite to the third wall portion, the fourth wall portion comprising the slot.

The oven of the first aspect may include any one or more of the previous embodiments, and optionally the periphery of the tunnel has a cross-sectional shape that is generally rectangular.

A second aspect of the disclosure is a method of curing a coating on a surface of a metallic workpiece, comprising: (1) positioning the metallic workpiece on a pin of a pin chain that extends through an oven; (2) operating the pin chain to move the metallic workpiece on the pin through a tunnel extending through a heater housing, the heater housing comprising: (a) a first end; (b) a second end spaced from the first end, the (c) tunnel extending through the heater housing from the first end to the second end, the tunnel comprising: (i) an entrance at the first end; (ii) an exit at the second end; and (iii) a wall extending from the first end to the second end, the wall defining a periphery of the tunnel, the periphery having a geometry to receive the metallic container body; (d) a slot extending through the wall, the slot extending from the entrance to the exit; (e) an enclosed area between exterior surfaces of the heater housing and the periphery of the tunnel, a portion of wall of the tunnel being positioned proximate to the pin chain with the pin chain positioned outside of the tunnel such that the pin extends through the slot to transport the metallic workpiece through the tunnel; and (f) an induction element within the enclosed area; and (3) providing electrical power to the induction element, wherein the induction element heats the metallic workpiece to a predetermined temperature.

Optionally, the method of the second aspect further comprises sending a signal from a control system to a power source associated with the induction element to adjust a heating output of the induction element.

The method of the second aspect optionally includes the previous embodiment, and in some embodiments the control system is operable to send the signal based on one or more of: (a) a velocity of the pin chain relative to the induction element; (b) a thermal conductivity of a metallic material of the metallic workpiece; (c) a predetermined rate of heating of the metallic workpiece; (d) a temperature to which the metallic workpiece will be heated; and (e) a type of the coating on the metallic container body.

The method of the second aspect optionally includes one or more of the previous embodiments, and in some embodiments the metallic workpiece is a metallic container body.

In some embodiments, the method of the second aspect further comprises curing a coating on an exterior surface of the metallic workpiece. Optionally, the method comprises drying the exterior surface.

Additionally, or alternatively, the method of the second aspect further comprises curing a coating on an interior surface of the metallic workpiece. Optionally, the method comprises drying the interior surface.

The method of the second aspect may optionally include one or more of the previous embodiments, and in some embodiments the wall of the tunnel further comprises: (a) a first wall portion; (b) a second wall portion opposite to the first wall portion; (c) a third wall portion extending from the first wall portion to the second wall portion; and (d) a fourth wall portion opposite to the third wall portion, the fourth wall portion comprising the slot.

Additionally, or alternatively, the method of the second aspect further comprises operating a ventilation system to selectively remove air from the tunnel.

In at least one embodiment, the ventilation system comprises a duct and a first port to draw air with contaminates from a first portion of the tunnel.

Optionally, the ventilation system further comprises a second port to draw air with contaminates from a second portion of the tunnel.

The method of the second aspect may optionally include one or more of the previous embodiments, and in some embodiments the method further comprises operating the ventilation system to selectively withdraw air from one or more of: (1) only the first port; (2) only the second port; and (3) both the first and second ports.

In some embodiments, the method of the second aspect comprises any one or more of the previous embodiments, and optionally further comprises operating a damper to change a volume of air removed from the tunnel, the damper being associated with the first port, the damper being adjustable from an open position to a closed position, and the being damper adjustable to a plurality of intermediate positions between the open and closed positions.

The method of the second aspect may optionally include one or more of the previous embodiments, and optionally the ventilation system further comprises a thermocouple to measure a temperature of the air withdrawn from the tunnel.

In some embodiments, the method further comprises adjusting operation of the ventilation system to maintain the temperature of air in the tunnel within a predetermined range.

In one or more embodiment, the predetermined temperature range is between about 285° F. and about 415° F.

The method of the second aspect may optionally include one or more of the previous embodiments, and optionally further comprises adjusting operation of the ventilation system to maintain the tunnel at less than 1 atmosphere of pressure during operation of the oven.

The method of the second aspect may optionally include one or more of the previous embodiments, and may optionally further comprise operating a cooling element associated with the induction element such that the cooling element maintains the induction element within a predetermined operating temperature during operation of the oven.

A third aspect of the disclosure is to provide a non-transitory computer readable medium including instructions configured to cause a processor of a control system to perform a method of heating a metallic workpiece in an oven, comprising: (1) sending a first signal to a power source associated with an induction element of the oven, the induction element positioned at least partially within an enclosed area of a heater housing within the oven, wherein the induction element heats the metallic workpiece to a predetermined temperature; (2) receiving a temperature of air withdrawn from a tunnel through the heater housing; and (3) sending a second signal to a damper of a ventilation system to alter a volume of the air withdrawn from the tunnel to maintain air within the tunnel within a predetermined temperature range.

A fourth aspect of the disclosure is to provide a heater housing for curing a coating on a surface of a metallic workpiece transported through an oven on a pin of a pin chain, the heater housing comprising: (1) a first end; (2) a second end spaced from the first end; (3) a tunnel extending through the heater housing from the first end to the second end, the tunnel comprising a wall defining a periphery of the tunnel, the periphery having a geometry to receive the metallic workpiece; (4) a slot extending through the wall to the tunnel, the slot extending from the first end to the second end, a width of the slot being greater than a diameter of the pin such that the pin can extend through the slot to transport the metallic workpiece through the tunnel when the oven is in operation; (5) an enclosed area between exterior surfaces of the heater housing and the periphery of the tunnel; and (6) an induction element at least partially within the enclosed area of the heater housing, the induction element operable to heat the metallic workpiece.

In some embodiments, a portion of the wall is positioned between the induction element and an interior of the tunnel,

The heater housing may comprise any one or more of the previous embodiments, and further comprises the wall of the tunnel being configured such that the pin can transport the metallic container body through the tunnel during operation of the oven such that the exterior surface of the metallic container body does not contact the tunnel.

The heater housing of the fourth aspect may optionally include the previous embodiment, and the tunnel of the heater housing optionally further comprises one or more of: (a) a first wall portion; (b) a second wall portion opposite to the first wall portion; (c) a third wall portion extending from the first wall portion to the second wall portion; and (d) a fourth wall portion opposite to the third wall portion and extending at least partially between the first wall portion and the second wall portion, with the slot extending through the fourth wall portion.

The heater housing may comprise one or more of the previous embodiments, and optionally the periphery of the tunnel has a cross-sectional shape that is generally rectangular.

In at least some embodiments, the heater housing of the fourth aspect may include one or more of the previous embodiments and may further comprise the first wall portion being positioned between the induction element and an interior of the tunnel.

The heater housing of the fourth aspect may include one or more of the previous embodiments and one or more of the first wall portion, the second wall portion, and the third wall portion is formed of a material that is non-magnetic.

In some embodiments, the material is non-metallic.

Optionally, the material is heat resistant.

In at least some embodiments, the fourth wall portion is formed of the material that is one or more of non-magnetic, non-metallic, and heat resist

The heater housing of the fourth aspect may include one or more of the previous embodiments, and the induction element comprises an inductor to create an electromagnetic field and produce an eddy current in the metallic workpiece.

The heater housing of the fourth aspect optionally includes one or more of the previous embodiments, and in some embodiments the metallic workpiece is a metallic container body.

In some embodiments, the heater housing of the fourth is configured to at least partially cure a coating on an exterior surface of the metallic workpiece. Optionally, the heater housing of the fourth is configured to dry the exterior surface.

Additionally, or alternatively, the heater housing of the fourth is configured to at least partially cure a coating on an interior surface of the metallic workpiece. Optionally, the heater housing is configured to dry the interior surface.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

The terms “metal” or “metallic” as used hereinto refer to any metallic material that may be used to form a container, including without limitation aluminum, steel, tin, copper, and any combination thereof.

Although generally referred to herein as a “container body” or a “metallic container,” it should be appreciated that the methods and apparatus described herein may be used to cure coatings or dry metallic workpieces of any size, shape, or type. Further, the methods and apparatus of the present disclosure may be used to cure coating or dry a metallic workpiece (such as but not limited to a container body or a metallic container) formed by any method, including draw and wall ironing (DWI) methods and impact extrusion methods. In some embodiments, the metallic workpieces include without limitation a metallic beverage bottle, a metallic beverage container or can, an aluminum bottle, a two-piece container, a two-piece can, a can, an aerosol container, a cylindrical food container, or a metal cup. A container body generally includes a closed endwall, a sidewall that may be generally cylindrical, and an open end.

As used herein, a “container body” may be formed into a two-piece can or a metallic bottle.

References herein to “a coating” include one or more of an ink, a basecoat, a varnish, an exterior coating and similar coatings on an interior surface or an exterior surface of a container body.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 5% of the stated value.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1 is a front perspective view of an oven according to embodiments of the present disclosure;

FIG. 2 is a rear perspective view of the oven of FIG. 1;

FIG. 3 is another front perspective view of the oven of FIG. 1 with exterior plates removed to illustrate interior components of the oven;

FIG. 4 is a front elevation view of components of the oven of FIG. 1 illustrating portions of a pin chain relative to heater housings of the oven;

FIG. 5 is a rear perspective view of a portion of the oven illustrating portions of a ventilation system relative to heater housings of the oven;

FIG. 6A is a view of a portion of a heater housing of the oven taken along line 6A-6A of FIG. 4;

FIG. 6B is another view of the portion of the heater housing of FIG. 6A and showing a second end of the heater housing;

FIG. 6C is a perspective view of a portion of a tunnel relative to a heater housing according to embodiments of the present disclosure;

FIG. 7 is a cross-sectional view of a portion of the heater housing of FIG. 6A taken along line 7-7;

FIG. 8 is a schematic view of a control system according to embodiments of the present disclosure;

FIG. 9 is a front elevation view of a metallic container; and

FIG. 10 is a front elevation view of a metallic bottle.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment or one aspect may be combined with or substituted for features or devices of other embodiments or other aspects regardless of whether or not such a combination or substitution is specifically shown or described herein.

The following is a listing of components according to various embodiments of the present disclosure, and as shown in the drawings:

| Number | Component |
|---|---|
| 2 | Metallic container |
| 4 | Container body |
| 6 | Sidewall |
| 6A | Lower sidewall portion |
| 6B | Medial sidewall portion |
| 6C | Distal sidewall portion |
| 8 | Exterior surface of container body |
| 10 | Hollow interior of container body |
| 12 | Interior surface of container body |
| 14 | Closed endwall (bottom) |
| 16 | Dome |
| 17 | Neck |
| 18 | Open end of the container body |
| 20 | Longitudinal axis of container |
| 22 | Upstream equipment |
| 23 | Downstream equipment |
| 24 | Oven |
| 25 | Frame |
| 26A | Exterior plate of oven |
| 26B | Access panel of oven |
| 28 | Entrance |
| 30 | Exit |
| 32 | Power source |
| 34 | Heater housing |
| 36 | Induction element |
| 38 | Inductor |
| 39 | Bend or turn |
| 40A | First end |
| 40B | Second end |
| 42 | Tunnel |
| 44A | First opening or entrance |
| 44B | Second opening or exit |
| 46A | First wall |
| 46B | Second wall |
| 46C | Third wall |
| 46D | Fourth wall |
| 48 | Slot |
| 49 | Seal or gasket |
| 49A | First seal portion |
| 49B | Second seal portion |
| 50 | Outer surface |
| 51 | Enclosed area (or open area) |
| 52 | Cooler |
| 54 | Tube of cooler |
| 58 | Conveyor system |
| 60 | Motor |
| 62 | Roller, sprocket, or gear |
| 66 | Pin chain |
| 70 | Pin |
| 72 | Projection of pin |
| 74 | Tunnel extension |
| 82 | Central axis of pin |
| 84 | Ventilation system |
| 85 | Fan |
| 86 | Exhaust handling element |
| 88 | Duct |
| 89 | Vent, port, louver, nozzle or perforations of duct |
| 90 | Adjustment device |
| 92 | Distance between inductor and tunnel wall |
| 99 | Air monitor |
| 100 | Control system |
| 102 | Bus |
| 104 | CPU |
| 106 | Input devices |
| 108 | Output devices |
| 110 | Storage devices |
| 112 | Computer readable storage media reader |
| 114 | Communication system |
| 116 | Working memory |
| 118 | Processing acceleration unit |
| 120 | Database |
| 122 | Network |
| 124 | Remote storage device/database |
| 126 | Operating system |
| 128 | Other code |
| X | Lateral dimension |
| Y | Longitudinal dimension |
| Z | Vertical dimension |

### DETAILED DESCRIPTION

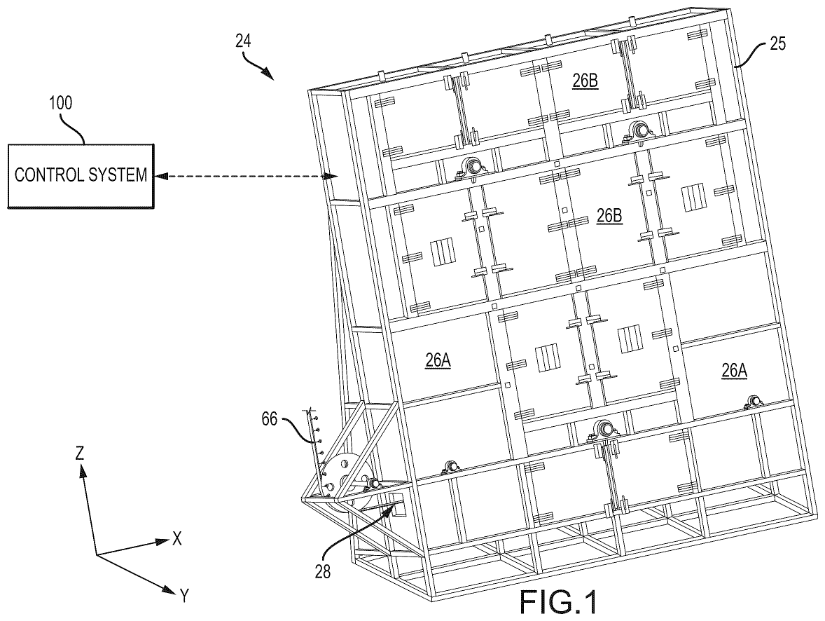

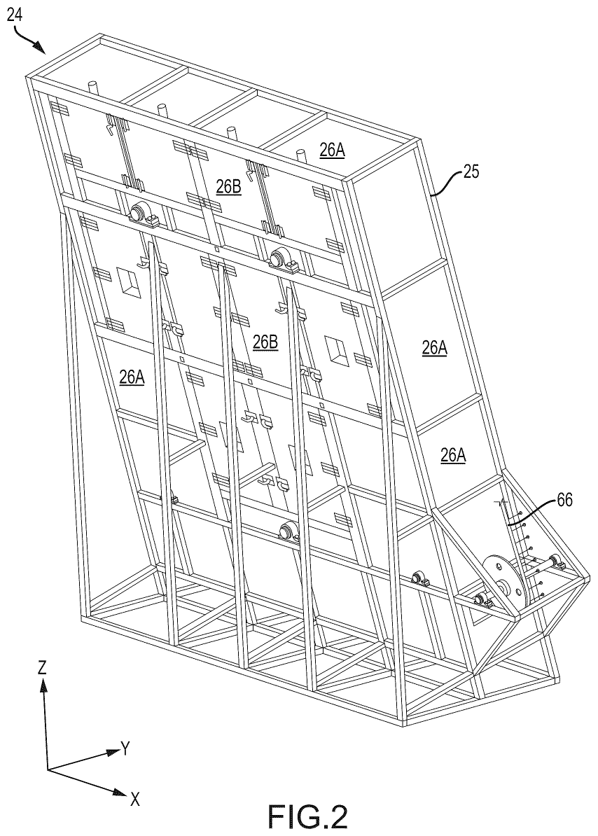

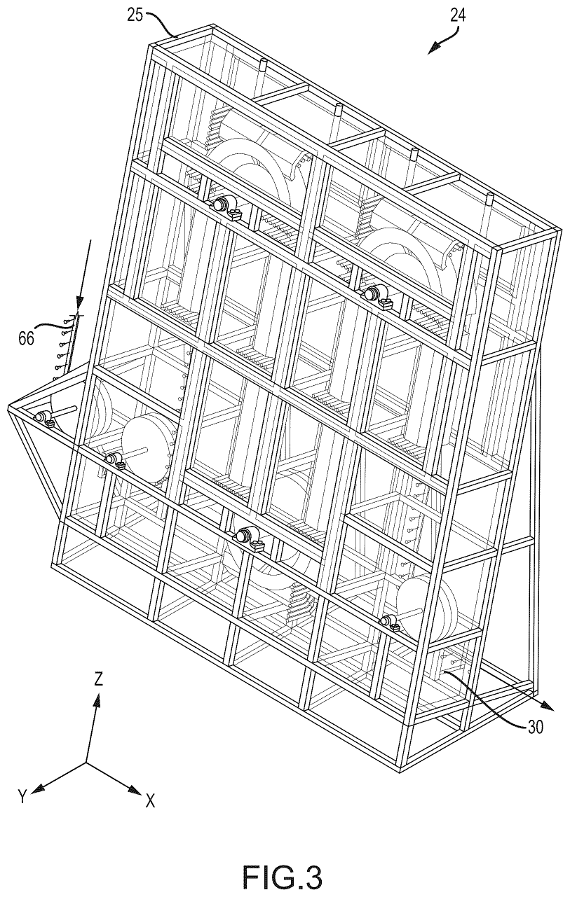

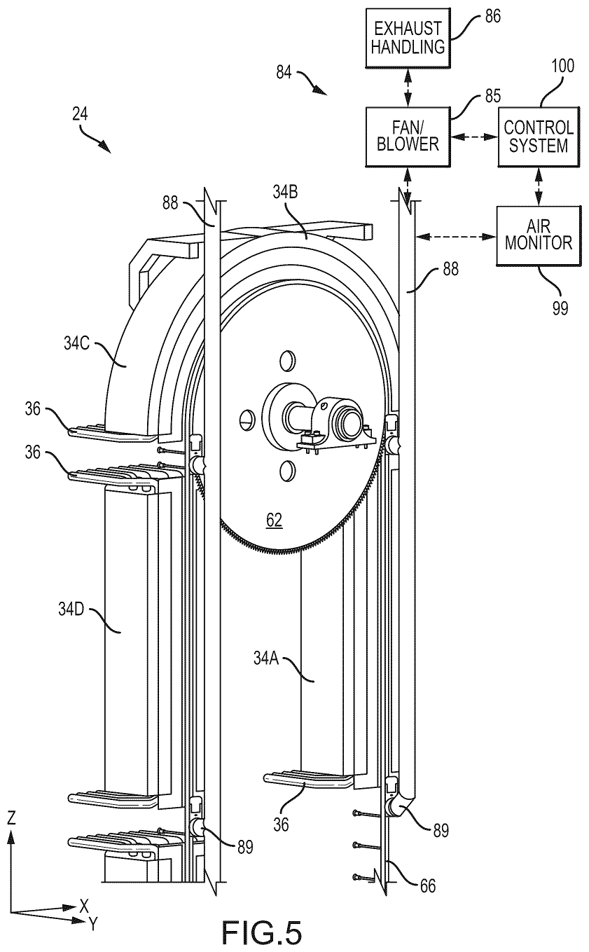

Referring now to FIGS. 1-7, an oven 24 is provided according to embodiments of the present disclosure and is generally illustrated. The oven 24 includes induction elements 36 which are powered with electricity to heat container bodies of metallic containers to dry moisture, cure a coating, and/or cure an ink. The electricity may optionally be provided by a renewable source, such as solar or wind energy.

The oven 24 generally includes a frame 25. Exterior plates 26A and/or access panels 26B may optionally be connected to the frame to at least partially, or completely, enclose the frame 25. However, unlike a conventional pin oven, the oven 24 of the present disclosure does not require the exterior plates 26 to intentionally retain heat within a volume defined by the frame. Accordingly, in at least some embodiments, the oven of the present disclosure is not completely enclosed.

The oven 24 of the present disclosure comprises one or more heater housings 34 which each have at least one induction element 36 that use electricity to heat container bodies 4 as they are transported by a conveyor system 58. In embodiments, the conveyor system includes an endless loop, such as a pin chain 66. Optionally, the oven 24 includes a control system 100 operable to control operation of the oven and the conveyor system.

In embodiments, the pin chain 66 may optionally have a generally vertical layout. For example, in some embodiments the pin chain 66 follows non-linear path through the oven 24 comprising a number of vertical segments similar to the path of a pin chain of a conventional pin oven.

Alternatively, the pin chain 66 of the present disclosure may have a generally horizontal layout, or include a combination of horizontal and vertical segments. In some embodiments, the pin chain 66 may have a linear path through the oven 24 of the present disclosure.

The oven 24 can be of any size or shape. In embodiments, the pin chain 66 enters the oven 24 at an entrance 28 and leaves the oven through an exit 30.

The oven 24 can be positioned downstream from upstream equipment 22 in a metallic container production facility. In embodiments, the upstream equipment 22 is a decorator and the oven 24 is a deco oven (or pin oven) configured to cure inks and varnish applied to an exterior surface of the container bodies.

The conveyor system 58 optionally includes a motor 60 that drives the pin chain 66 to move the container bodies 4 through the oven 24 at a rate that is variable. In some embodiments, the conveyor system 58 and the pin chain 66 are associated with the decorator. Accordingly, in at least some embodiments, the motor 60 is also associated with the decorator.

Any suitable motor known to those of skill in the art can be used with the oven 24 of the present disclosure. Optionally, the motor 60 is a servo motor. In embodiments, the control system 100 can send signals to the motor to stop or alter the rate of movement of the pin chain 66. The pin chain 66 optionally defines an endless loop.

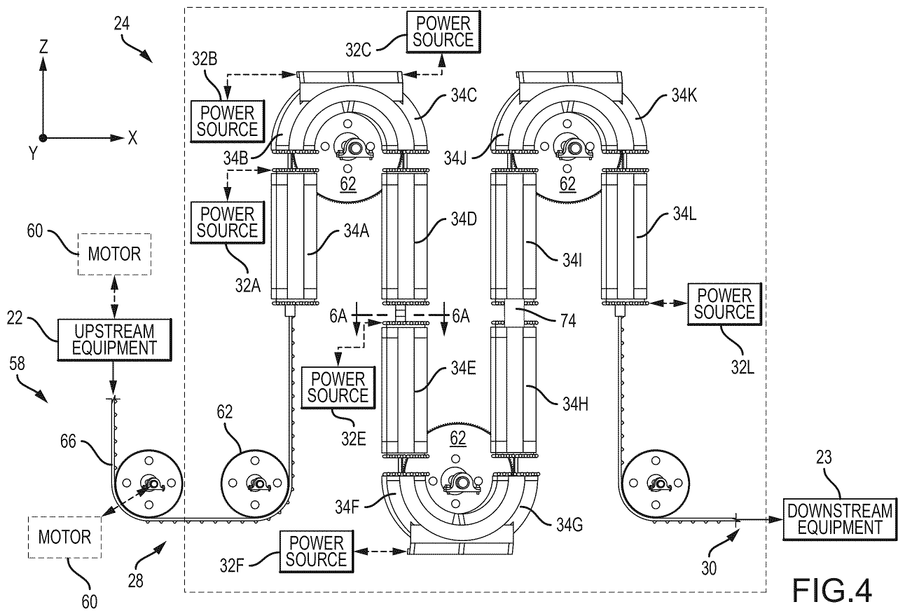

Optionally, the pin chain 66 follows a serpentine path through the oven 24. For example, as generally illustrated in FIG. 4, the pin chain 66 may include segments oriented generally upwardly (relative to the vertical dimension Z) and segments oriented generally downwardly. In embodiments, the conveyor system 58 includes a plurality of rollers, sprockets, or gears 62. The pin chain 66 may change direction at a sprocket 62.

Alternatively, in other embodiments, the pin chain 66 is oriented generally parallel to a horizontal plane defined by the lateral dimension X and the longitudinal dimension Y. In still other embodiments, the pin chain 66 follows a generally linear path. Other configurations and orientations of the pin chain 66 and the conveyor system 58 are contemplated. The lateral dimension X, the longitudinal dimension Y, and the vertical dimension Z are substantially orthogonal to each other.

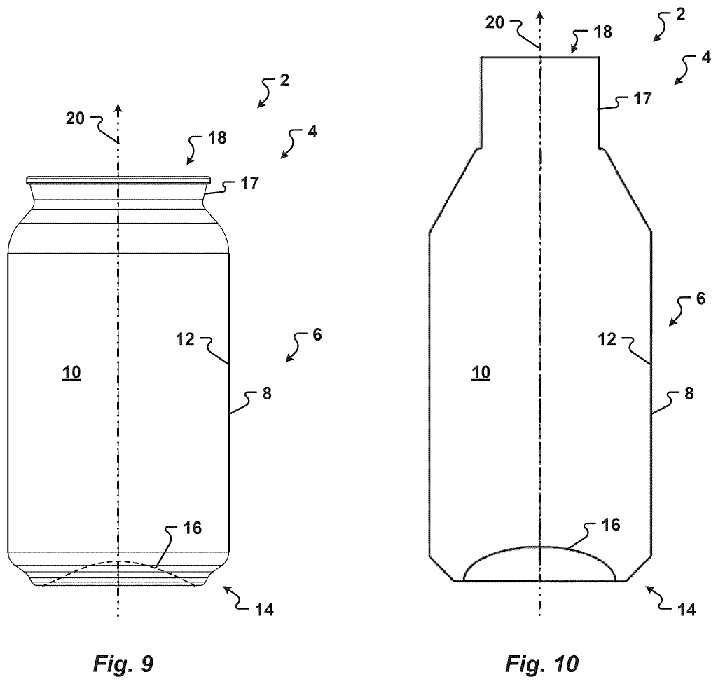

In embodiments, the motor 60 moves the pin chain 66 of the conveyor system 58 at a rate of between approximately 10 ft/sec and approximately 30 ft/sec. Optionally, the motor 60 drives the pin chain 66 at between approximately 20 ft/sec and approximately 25 ft/sec. In this manner, the pin chain 66 can transport between approximately 1,800 and approximately 2,500 containers per minute through the oven 24. In some embodiments, the conveyor system 58 is configured to transport the container bodies 4 past or through the heater housings 34 in a single row (or single file). For example, in some embodiments, the pin chain 66 transports the container bodies such that a longitudinal axis 20 of a container body (illustrated in FIG. 9) is oriented approximately perpendicular to a direction of movement of the pin chain. Further, the longitudinal axes of two adjacent container bodies 4 supported by the pin chain may be approximately parallel. However, the longitudinal axes to the two adjacent container bodies are not coaxially aligned.

In some embodiments, the conveyor system 58 is not configured to rotate the container bodies 4 around their longitudinal axes 20. Alternatively, in other embodiments, the conveyor system 58 is operable to selectively rotate the container bodies 4 around their longitudinal axes 20. In this manner, the sidewall 6 of a container body 4 may rotate relative to an adjacent induction element 36. Rotating the container body 4 is beneficial to provide even exposure to the induction elements 36 and to uniformly heat the container body.

Optionally, the pin chain 66 of the conveyor system 58 includes a projection or pin 70 to engage a container body. In some embodiments, the pin 70 is configured to engage an interior surface of the container body. However, in other embodiments, the pin may engage an exterior surface or the closed end of a container body.

In embodiments, each pin 70 is configured to fit into an open end 18 of a container body 4. In some embodiments, free ends of each pin 70 include a projection 72. When present, each projection 72 has a diameter that is greater than a diameter of its associated pin.

In some embodiments, the pins 70 are rotatable relative to the pin chain 66. In this manner, a pin 70 may selectively rotate around its central axis 82. Optionally, the pin chain 66 includes a clutch or a brake to selectively stop or adjust a rate of rotation of a pin.

Optionally, the conveyor system 58 includes drive means to rotate the pins. In embodiments, the drive means comprises a friction drive. For example, the conveyor system 58 may include a friction bar or drive bar positioned to engage pins 70 of the pin chain 66 as the pins move past the bar. In embodiments, the drive bar is substantially stationary relative to the pin chain 66. Accordingly, as a pin 70 of the pin chain moves relative to the drive bar and engages the drive bar, the pin rotates around its central axis 82 and rotates an engaged container body 4 around its longitudinal axis 20.

The pins 70 are substantially evenly spaced on the pin chain 66. In embodiments, the pins 70 have a spacing of between about 3 inches and about 9 inches. Optionally the spacing between adjacent pins 70 is approximately 5.25 inches. Other distances between pins 70 of the pin chain are contemplated.

In embodiments, the pins 70 are formed of a material that is non-conductive. Additionally, or alternatively, the pins may be formed of a non-magnetic material. In this manner, the pins of some embodiments of the present disclosure will not be heated by an induction element 36 of the present disclosure.

Referring now to FIGS. 4, 6A, 6B, 6C, and 7, a heater housing 34 of the oven 24 according to embodiments of the present disclosure is generally illustrated. The heater housing 34 generally comprises a first end 40A and a second end 40B spaced from the first end, an outer surface 50 that extends from the first end to the second end, and an induction element 36.

In some embodiments, the heater housing 34A is generally linear. In these embodiments, the first end 40A is positioned opposite to the second end 40B.

Alternatively, the heater housing 34B may have a shape that is not linear. For example, in some embodiments the heater housing 34B has a shape that is curved. A non-linear heater housing 34B may optionally be positioned proximate to sprocket 62 used to change a path of the pin chain through the oven 24. The curved heater housing 34B is adapted to extend along a portion of a circumference of the sprocket 62. This configuration is beneficial because heating of a container body 4 may optionally continue as the container body exits a linear heater housing 34A and enters an adjacent curved heater housing 34B.

In some embodiments, the heater housing 34B curves approximately 90° and the first end 40A is oriented approximately orthogonal to the second end 40B. Alternatively, in other embodiments, a heater housing may curve approximately 180° and the first and second ends 40A, 40B are approximately parallel.

In some embodiments, shielding is provided between the sprocket 62 and the heater housing 34B to protect the sprocket from electromagnetic fields produced by an induction element 36 associated with the heater housing 34B. Suitable materials to form the shielding are known to those of skill in the art. The shielding may optionally be formed of a ferromagnetic metal. In some embodiments, the shielding comprises copper to separate the sprocket 62 from the induction element 36.

A tunnel 42 extends through the heater housing 34. In some embodiments, the tunnel extends through the first end 40A and the second end 40B of the heater housing.

The tunnel 42 generally comprises a first opening 44A and a second opening 44B. The tunnel further comprises a wall 46 that defines a periphery of the tunnel. The wall 46 may comprise one or more wall portions 46A, 46B, 46C, 46D.

In some embodiments, the tunnel periphery has a generally rectangular cross-sectional shape sized to receive a container body 4. However, other shapes and configurations of the tunnel periphery are contemplated.

In embodiments in which the tunnel 42 has a rectangular shape (or cross-section), the tunnel comprises a first wall 46A and a second wall 46B positioned opposite to the first wall. A third wall 46C extends from the first wall to the second wall. A fourth wall 46D is positioned opposite to the third wall 46C. The fourth wall 46D extends at least partially between the first and second walls.

A slot 48 extends through the fourth wall 46D. The slot is optionally positioned approximately mid-way between (or equidistant from) the first and second walls 46A, 46B.

One or more ports or vents 89 may intersect the tunnel to move air and exhaust from the tunnel to ducts 88 of the ventilation system 84. In some embodiments, other than vents 89, the tunnel 42 has only three openings: the first opening 44A, the second opening 44B and the slot 48.

In at least some embodiments, the vents 89 may be used to direct air (or another gas) into the tunnel 42. For example, in at least one embodiment, a vent 89 may be connected to a source or supply of a gas that can be selectively directed into the tunnel. Optionally, the gas source or supply may comprise a heater to heat the gas to a predetermined temperature. Additionally, or alternatively, the gas source or supply may comprise a cooler to reduce the temperature of the gas to a predetermined temperature.

In at least one embodiment, the tunnel 42 includes at least one vent 89 connected to an integrated catalytic oxidizer (ICO) or integrated thermal oxidizer (ITO) associated with the ventilation system 84. In this manner, the vent may beneficially permit reacted air from the ICO/ITO to be directed into the tunnel 42.

The tunnel 42 may have any desired shape. More specifically, the tunnel 42 has a shape that generally corresponds to a path of the pin chain 66 through the oven 24.

In some embodiments, the tunnel is generally linear. Alternatively, the tunnel may include at least one curved segment. In some embodiments, the tunnel includes at least one linear segment joined to at least one curved segment.

The slot 48 has a shape that generally corresponds to the path of an adjacent portion of the pin chain 66. Additionally, in at least one embodiment, the tunnel 42 is positioned within the oven 24 such that the fourth wall 46D and the slot 48 are approximately parallel to a portion of the pin chain 66. Accordingly, where the path of the pin chain is non-linear, the slot 48 is shaped to substantially correspond to a path of the portion of the pin chain 66 that is proximate to the fourth wall. For example, the slot 48 may have a radius of curvature substantially equal to a radius of curvature of the portion of the pin chain 66 to which the heater housing 34B is proximate.

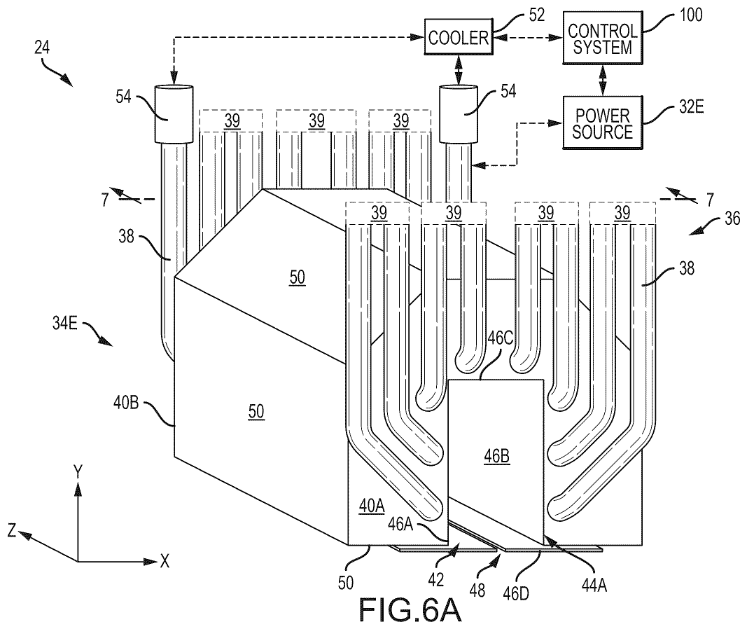

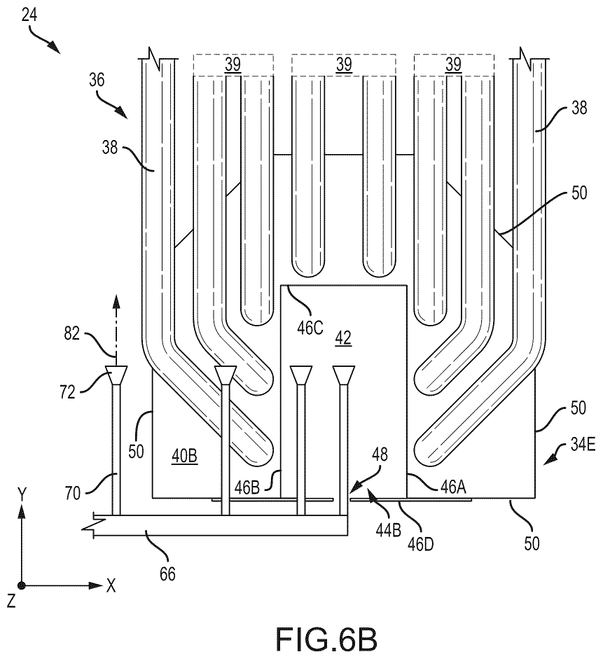

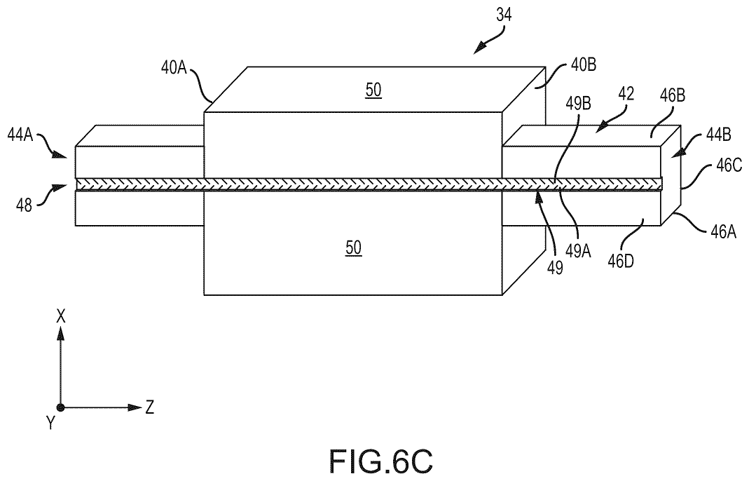

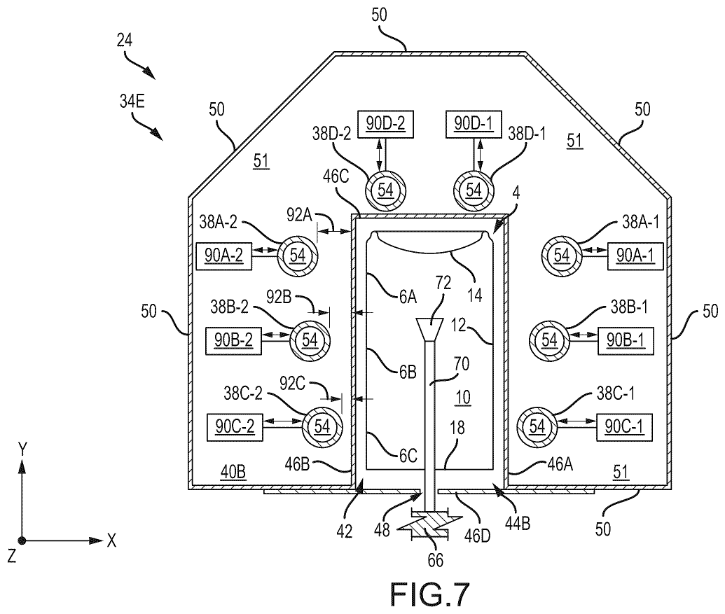

The slot 48 has a width that is greater than a diameter of a pin 70. In this manner, the slot 48 is configured to permit a pin to extend into the tunnel 42 as generally illustrated in FIGS. 6B and 7. Accordingly, when the oven 24 is in operation, a pin 70 may extend through the slot to transport a container body 4 through the tunnel 42.

Optionally, a gasket or seal 49 may at least partially close the slot 48. When present, the seal 49 beneficially reduces (or minimizes) the flow of air from the tunnel 42 through the slot 48. In this manner, the seal 49 can beneficially keep warm air in the tunnel 42. Another benefit of the seal 49 is to keep gases and vapor (or volatile organic compounds (VOCs)) that off-gas from the container bodies 4 when coatings on the container bodies are heated within the tunnel 42 to permit extraction of the VOCs at one or more desired locations.

As generally illustrated in FIG. 6C, the seal 49 may comprise a first seal portion 49A extending into the slot 48 from a first side of the fourth wall 46D. Additionally, or alternatively, the seal 49 may optionally comprise a second seal portion 49B extending into the slot 48 from a second side of the fourth wall 46D.

The seal 49 is configured and adapted to permit a pin 70 of the pin chain 66 to extend through the slot. Further, the seal will permit the pin 70 to move in the slot 48 from the entrance 44A of the tunnel to the exit 44B of the tunnel.

The seal 49 may be of any suitable type known to those of skill in the art. Further, the seal 49 may be formed of any suitable material. Optionally, the seal 49 comprises a flexible material.

In some embodiments, the seal 49 comprises a brush with a plurality of bristles. Optionally, free ends of the bristles are oriented toward the exit 44B of the tunnel.

In at least some embodiments, the cross-sectional shape of an interior of the tunnel 42 is substantially constant from the first opening 44A to the second opening 44B.

The tunnel 42 is optionally formed separately from the heater housings 34 of the present disclosure. Accordingly, the tunnel 42 may have a length extending along the path of the pin chain 66 that is greater than a length of a heater housing. For example, in some embodiments, the oven 24 may have a single tunnel 42 which extends through two or more heater housings 34.

The first wall 46A, the second wall 46B, the third wall 46C, and the fourth wall 46D extend from the first end 40A to the second end 40B of each heater housing 34. In at least one embodiment, the first, second, third and fourth walls of the tunnel extend from the second end 40B of a first heater housing continuously to the first end 40A of a second heater housing adjacent to the first heater housing.

Optionally, the first wall 46A, the second wall 46B, the third wall 46C, and the fourth wall 46D are approximately orthogonal to one another in at least one embodiment. However, the tunnel 42 may have any desired shape and may have walls with different relative orientations.

In some embodiments, the first, second, third, and fourth walls 46A, 46B, 46C, 46D of the tunnel 42 are formed of a material that is not affected by the induction element 36. For example, the material of one or more of the first, second, third, and fourth walls 46A, 46B, 46C, 46D may be non-metallic in some embodiments. Additionally, or alternatively, the material of one or more of the first, second, third, and fourth walls 46A, 46B, 46C, 46D optionally is non-magnetic. In addition, the material of one or more of the first, second, third, and fourth walls 46A, 46B, 46C, 46D may be heat resistant. In some embodiments, the material is a dielectric material. Suitable materials are known to those of skill in the art and may comprise one or more of a wood, a thermoplastic (such as an acrylic), aramid fiber, fiberglass, and a nitrile binder.

The tunnel 42 of the present disclosure beneficially reduces the volume of air that the ventilation system 84 must handle. In this manner, the tunnel 42 makes control of exhaust from the induction element 36 easier, decreases the cost of operating the ventilation system, and improves efficiency of the oven 24. For example, in some embodiments, the ventilation system 84 is configured to exhaust between about 100 ft³/minute to 600 ft³/minute. Optionally, in some embodiments, the ventilation system is configured to exhaust about 300 ft³/minute.

In some embodiments, the tunnel 42 has an interior volume of between about 20 ft³ and about 100 ft³. In at least one embodiment, the interior volume of the tunnel 42 is about 50 ft³.

In at least one embodiment, the heater housing 34 is positioned within the oven 24 such that the fourth wall 46D of the tunnel 42 is positioned proximate to a portion of the pin chain 66 with the pin chain positioned outside of the tunnel. In some embodiments, the fourth wall is approximately parallel to a plane defined by the portion of the pin chain.

In some embodiments, the fourth wall 46D of the tunnel 42 defines a portion of the outer surface 50 of the heater housing 34E. The slot 48 of the tunnel extends from the first end 40A to the second end 40B of the heater housing.

Referring now to FIG. 7, in at least one embodiment, the heater housing optionally comprises an open space or enclosed area 51 between the outer surface 50 of the heater housing and exterior surfaces of the tunnel 42. The enclosed area 51 is optionally substantially sealed to prevent (or limit) ingress of one or more of gases and liquids into the enclosed area. In this manner, VOCs in the tunnel 42 are prevented from entering the enclosed area 51.

The induction element 36 includes at least one portion (or an inductor 38) positioned at least partially within the enclosed area 51 of the heater housing 34. For example, in some embodiments, a portion of the induction element (the inductor 38) extends through one or more of the first end 40A, the second end 40B and the outer surface 50 of the heater housing and into the enclosed area 51.

Notably, the induction element 36 and its inductors 38 are spaced from an interior of the tunnel 42 by one or more of the first, second and third walls 46A, 46B, 46C. Specifically, one of the first, second and third walls 46A, 46B, 46C is positioned between the induction element 36 and a container body 4 in the tunnel 42.

This arrangement of the induction element 36 is beneficial to prevent exposure of the induction element (and the inductor 38) to gases and vapor (or volatile organic compounds (VOCs)) that off-gas from the container bodies 4 as the coatings on the container bodies are heated within the tunnel 42. As will be appreciated by one of skill in the art, preventing contact of gaseous VOCs with the induction elements is beneficial because the induction elements have an operating temperature that is less than the condensation temperature of the VOCs. Thus, preventing gaseous VOCs from contacting the induction element (including its inductors, coils (if any) and conductors) reduces or prevents condensation of VOCs within the oven 24.

Positioning the pin chain 66 outside the tunnel 42 is also beneficial for a variety of reasons. First, because VOCs released from container bodies as the coatings are heated are concentrated within the tunnels 42, the pin chain is not exposed to VOCs in the tunnels.

Another benefit is that the pin chain 66 is not exposed to the hot air within the tunnels 42. This is beneficial because it reduces the thermal cycling that pin chains are subjected to when repeatedly entering and exiting prior art pin ovens. In contrast, the pin chain 66 is only exposed to air in the oven which is outside of the tunnel. The air in the oven outside of the tunnel may be at a temperature of between approximately 70° F. and approximately 150° F.

Still another benefit of positioning the heater housing 34 such that the pin chain 66 is outside of the tunnel 42 is that the size and volume of the tunnel is reduced. More specifically, if the pin chain was positioned within the tunnel 42, the size and volume of the tunnel would need to be increased to accommodate the pin chain and associated equipment (such as sprockets 62). As described herein, minimizing the volume of the tunnel is beneficial because it reduces requirements of the ventilation system 84. Moreover, reducing the volume of the tunnel is beneficial because it concentrates heat radiated from the heated container bodies 4 within the tunnel, and the warm air in the tunnel can help cure the coating on the containers.

Referring again to FIG. 7, inductors 38 of the induction element 36 are optionally positioned within the enclosed area 51 proximate to one of the first, second and third walls 46A, 46B, 46C of the tunnel. Optionally, two or more induction elements 36 may be positioned within the enclosed area 51 to provide substantially uniform heating to the container bodies 4.

The size and geometry of the induction element 36 (or inductors 38 of the induction element) determine the shape of the electromagnetic field. Accordingly, the induction element has a geometry to generate an electromagnetic field of sufficient size and strength to heat the container body.

Referring to FIG. 6A, in some embodiments, a heater housing 34 may include multiple separate induction elements 36 with multiple individual inductors 38. For example, a heater housing 34 may optionally have one to ten separate induction elements 36 which each has at least one corresponding inductor 38 and a power source 32. In one embodiment, a heater housing has eight separate induction elements 36 which each has one inductor positioned proximate to the tunnel 42. In this manner, each inductor 38 may be adjusted to provide an electromagnetic field adjusted to heat a particular portion of a container body 4.

Alternatively, in some embodiments, a heater housing 34 has only one induction element 36 associated with one power source 32. The induction element 36 is arranged such that multiple portions (or inductors 38) of the induction element within the enclosed area 51 are proximate to exterior surfaces of the tunnel 42.

As generally illustrated in FIG. 6A, the induction element 36 may include bends or turns 39 between adjacent inductors 38. However, other arrangements of the induction element and its inductors are contemplated.

Each inductor 38 may have any suitable shape. In some embodiments, the inductors 38 have a shape that generally corresponds to an exterior surface of the tunnel 42. The inductors 38 may extend along a length of the tunnel 42 (where the length of the tunnel 42 follows the path of the pin chain). For example, proximate to portions of the tunnel that are linear, the inductors 38 are substantially linear. Additionally, or alternatively, proximate to portions of the tunnel that are curved, the inductors 38 correspondingly curve.

Notably, the inductors 38 do not wrap around the exterior of the tunnel. If the inductors wrapped around the tunnel, the inductors 38 might interfere with the pin chain, or heat the pin chain. Instead, the inductors 38 are only positioned proximate to one, two, or three sides (or walls 46A, 46B, 46C) of the tunnel.

Each inductor 38 is spaced a predetermined distance from one or more adjacent inductors. In at least one embodiment, adjacent inductors 38 do not contact each other. As will be appreciated by one of skill in the art, when inductors 38 are too close together, they may cause interference with one another and reduce efficiency.

Optionally, the induction element may have multiple inductors 38 positioned within the enclosed area 51. For example, in at least one embodiment, at least one inductor 38 is positioned proximate to the first wall 46A of the tunnel, at least one inductor 38 is positioned proximate to the second wall 46B of the tunnel, and at least one inductor 38 is positioned proximate to the third wall 46C of the tunnel.

In at least one embodiment, no inductors are positioned proximate to the fourth wall 46D of the tunnel. This is beneficial because, as generally illustrated in FIG. 7, when a container body 4 is transported through the tunnel, an open end 18 of the container body is positioned proximate to the fourth wall 46D. Further, the pin chain 66 is proximate to the fourth wall 46D, and thus by not positioning an inductor by the fourth wall 46D, the pin chain is spaced from the inductors which protects the pin chain from heating by the induction element.

In some embodiments, a heater housing 34 comprises eight induction elements 36 (or eight inductors 38 of an induction element 36). For example, three inductors 38 may be positioned proximate to the first wall 46A of the tunnel 42. Similarly, three inductors 38 may be positioned proximate to the second wall 46B. Two more inductors 38 are positioned proximate to the third wall 46C in at least one embodiment.

As generally illustrated in FIG. 7, in embodiments the induction element (or inductors 38 of the induction element 36) are arranged to extend along the sidewall 6 and a closed endwall 14 of a container body 4 transported through the tunnel by a pin 70 of the pin chain 66. Other configurations and orientations of the induction element 36 (and its inductors 38) are contemplated.

In embodiments, the induction element 34 (or its inductors 38) is configured to be less than approximately 1 inch from the sidewall 6 of the container body. In embodiments, the inductors 38 are between approximately 0.04 inches and approximately 1 inch from the sidewall. Optionally, the inductors are between approximately 0.05 inches and approximately 0.2 inches from the sidewall.

In other embodiments, the induction element 34 (or its inductors 38) is configured to be less than approximately 1 inch from the closed endwall 14 of the container body. In some embodiments, the inductors 38 are between approximately 0.04 inches and approximately 1 inch from the closed endwall. Optionally, the inductors 38 are between approximately 0.05 inch and approximately 0.2 inches from the closed endwall.

As will be appreciated by one of skill in the art, container bodies 4 typically do not have a consistent thicknesses throughout their sidewalls. More specifically, a lower portion 6A of the sidewall 6 proximate to the closed endwall 14 may have a first thickness that is less than a second thickness of a medial portion of the sidewall 6B. Further, a distal portion of the sidewall 6C proximate to the open end 18 may have a third thickness that is greater than the second thickness and the first thickness.

As will be appreciated by one of skill in the art, the amount of heat produced within a workpiece by induction heating is directly related to the separation distance between the workpiece and an inductor. Accordingly, positioning inductors 38 of the present disclosure at different distances from the tunnel (and a container body 4 when present on a pin 70) can facilitate uniform heating of portions of a sidewall of a container body that have different thicknesses. In some embodiments the inductors 38 are spaced different distances 92 from the first wall 46A and the second wall 46B of the tunnel 42 to evenly heat the sidewall 6 of the container body.

Referring now to FIG. 7, optionally two inductors 38A-1, 38A-2 positioned proximate to the lower sidewall portion 6A are positioned a first distance 92A from the first wall 46A and the second wall 46B. Two inductors 38B-1, 38B-2 positioned proximate to the medial sidewall portion 6A are positioned a second distance 92B from the first wall 46A and the second wall 46B. The first distance 92A is greater than the second distance 92B because the lower sidewall portion 6A is typically thinner than the medial sidewall portion 6B. Accordingly, the lower sidewall portion 6A requires less exposure to eddy currents from the inductors to heat to a predetermined temperature.

Continuing this example, two inductors 38C-1, 38C-2 positioned proximate to the distal sidewall portion 6C are optionally positioned a third distance 92C from the first wall 46A and the second wall 46B. The third distance 92C is less than the second distance 92B and the first distance 92A because the distal sidewall portion 6C is typically thicker than the medial and lower sidewall portions 6B, 6A.

Optionally, portions of the induction element 36 may be moveable relative to the tunnel 42 (and a container body 4 when present on a pin 70). Accordingly, in some embodiments, one or more of the first distance 92A, the second distance 92B, and the third distance 92C can be adjusted. In this manner, the position of the induction element may be adjusted to account for container bodies 4 of different sizes, shapes, and materials. Moreover, the position of the inductors 38 may be adjusted relative to the container body to account for the shape of the electromagnetic field generated by the induction element 36.

Optionally, an actuator or adjustment device 90 is operably engaged with one or more of the inductors 38. The adjustment device 90 can optionally move and associated inductor 38 toward or away from the tunnel. More specifically, an adjustment device 90A-2 may move inductor 38A-2 to adjust the distance 92A.

In some embodiments, each inductor 38 has an associated adjustment device 90. For example, an adjustment device 90A-1 is associated with inductor 38A-1, an adjustment device 90A-2 is associated with inductor 38A-2, an adjustment device 90B-1 is associated with inductor 38B-1, an adjustment device 90B-2 is associated with inductor 38B-2, an adjustment device 90C-1 is associated with inductor 38C-1, an adjustment device 90C-2 is associated with inductor 38C-2, an adjustment device 90D-1 is associated with inductor 38D-1, and an adjustment device 90D-2 is associated with inductor 38D-2.

In some embodiments, the control system 100 can send a signal to an adjustment device 90 to move an associated inductor 38 in one or more directions.

Any suitable induction element 36 known to those of skill in the art may be used in the heater housings 34 of the present disclosure. In some embodiments, an induction element 36 of the present disclosure is connected to a power source 32 that supplies an electric current to the inductors 38. Electricity flowing through the inductors 38 creates an electromagnetic field. As the pin chain 66 transports a container body 4 past the inductors 38, the magnetic field induces eddy currents in the metallic material of the container body 4 to heat the container body. In this manner, the induction element 36 heats the container body directly. In contrast, conventional ovens use warm air in the oven to heat container bodies.

In embodiments, the induction element 36 includes an electromagnet and optionally an electronic oscillator. The power source 32 may comprise an induction generator and a transformer.

One benefit of the induction element 36 of the present disclosure is that the electromagnetic field and the induced eddy currents rapidly heat the container body. Another benefit is that heating of the container body 4 by the induction element stops as soon as the induction element 36 is turned off.

The frequency, voltage, duty cycle and current of the electricity provided by the power source 32 to the induction element 36 are selected to produce an electromagnetic field with predetermined parameters. As generally illustrated in FIG. 4, each heater housing 34 optionally has a power source 32. Thus, in some embodiments, each power source 32 is associated with one inductor element 36. In this manner, the amount of heating provided by each inductor element 36 can be individually adjusted. Multiple inductor elements 36 (and heater housings 34) give greater control of the heating of the container bodies passing through the oven 24. In contrast, if an oven has only one heater housing with only one inductor 36, the oven has only one zone.

The parameters of the electric current provided by the power source 32 can be adjusted depending upon the amount of heating required for the metallic container. For example, the heating requirements (such as the curing temperature) for a container body or other metallic workpiece depend upon the types of coatings, including one or more of the type of ink, the color of the ink, and the type of varnish. The parameters of the electric current may also be adjusted based on one or more of: a thickness of a metallic material of a container body 4, a mass of the container body, a rate at which the container body will be heated, a rate of movement of the container body relative to the induction element, a rate of rotation of the container body around its longitudinal axis relative to the induction element, a distance of an exterior surface of the container body from the induction element 36, a composition of the metallic material of the container body, and a thermal conductivity of the metallic material of the container body.

In embodiments, the control system 100 can send a signal to the power source 32 to change one or more of the frequency, voltage, duty cycle and current to alter electromagnetic field. The control system 100 can adjust the amount, type, and duration of electric current provided to the induction element 36. In this way, the control system 100 can adjust the rate of heating and the amount of heat the induction element provides to the container body to account for a type of coating or a type of ink on the container body, the material of the container body (such as the type of metallic material and the mass of the container body), and a rate of movement of the conveyor 58 (or the pin chain 66) (and the container body) relative to the induction element.

In embodiments, the power source 32 provides a high frequency alternating electric current to the induction element 36. Optionally, the frequency of the electric current is between approximately 60 Hz and approximately 30,000 Hz. In some embodiments, the frequency is between approximately 1 kHz and approximately 5 kHz, or about 3 kHz. In embodiments, the current is 3-phase. In other embodiments, the voltage is between approximately 200 volts and approximately 800 volts.

The electromagnetic field rapidly heats the metallic material of the container body 4 to a predetermined curing temperature required to cure coatings on the container body 4 or to dry fluid (such as water) on the container body. The heated metallic material then heats and cures (or at least partially cures) inks and other coatings, including varnish, on the container body. In this manner, the induction element 36 heats the container body first and the container body then heats the inks and other coatings to the curing temperature. Heating the coatings from the container body out (rather than by convection as in a prior art oven) is beneficial because it reduces bubble formation and skinning of the coatings.

Because the induction element 36 heats the container body directly, air within the oven 24 can be at a lower temperature than the curing temperature required to cure the coatings. In embodiments, the curing temperature is between approximately 350° F. to approximately 410° F. In other embodiments, the curing temperature is approximately 370° F., or approximately 390° F. In some embodiments, the curing temperature is less than or equal to 400° F. The induction elements 36 of the present disclosure can be set to heat a container body 4 to a different predetermined curing temperature depending upon the types of inks and coatings on the container body.

Because the air within the oven 24 of the present disclosure is not used to heat the inks and coatings, the air in the oven can be at a temperature that is lower than the curing temperature. For example, in embodiments, air within an area defined by the frame 25 of the oven 24 (and outside of a tunnel 42 of a heater housing 34) can have a temperature of less than approximately 325° F. In some embodiments, air outside of the tunnel 42 and within the oven may have a temperature of between approximately 70° F. and approximately 150° F.

In embodiments, the air within a tunnel 42 may be allowed to heat up as container bodies 4 are heated. The heated air within a tunnel 42 may beneficially help cure a coating on a container body.

In some embodiments, air within a tunnel 42 of a heater housing is maintained at a temperature between a predetermined minimum temperature and a predetermined maximum temperature. In some embodiments, the predetermined minimum temperature is about 285° F. Optionally, the predetermined minimum temperature is about 300° F. In some embodiments, the predetermined maximum temperature is about 415° F. Optionally, the predetermined maximum temperature is approximately 400° F. In some embodiments, the air within the tunnel 42 is maintained at between about 285° F. and about 415° F. when the oven is in operation. These temperatures are beneficial to keep VOC's released from container bodies from condensing within the tunnel 42 or the oven 24.

More specifically, in embodiments, the predetermined minimum temperature is the temperature at which VOC's released from the container bodies as the inks and coatings are heated will condense. The predetermined minimum temperature is selected to keep VOC's in a gaseous or vapor state and to prevent VOC's from condensing within the oven.

A temperature measuring device may be positioned within the oven 24 to determine the temperature of air within tunnel 42. In some embodiments, one or more temperature measuring devices are positioned within a tunnel 42. Additionally, or alternatively, one or more temperature measuring devices may be positioned within a duct 88 of the ventilation system 84.

Any suitable temperature measuring device may be used. In embodiments, the temperature measuring device is one or more of a thermometer, a thermistor, and a thermocouple. The optional control system 100 may receive data from the temperature measuring device. The control system 100 may send a signal to the ventilation system 84 to alter a volume of air removed from a tunnel 42 to adjust the temperature of air with the tunnel based on data received from the temperature measuring device. For example, the signal from the control system 100 can adjust the operation of a fan 85 of the ventilation system as necessary to keep the air temperature in the tunnel 42 below a predetermined level or within a predetermined range. In embodiments, the control system 100 can send a signal to a motor of the fan 85 to adjust the air temperature in the tunnel 42 and prevent condensation of VOCs and drips of the VOCs onto a container body 4.

Reducing the volume of air heated by the oven 24 provides many benefits. First, energy (such as a fossil fuel) is not used to heat a large mass of air to the curing temperature. This also reduces waste heat that is radiated from the oven 24 to the container production facility.

Another benefit of reducing the volume of hot air within the oven 24 is reduction or elimination of spoilage if the conveyor system 58 stops. More specifically, in embodiments, when the pin chain 66 stops, the power source 32 will stop supplying electricity to the induction element 36. The induction element 36 will stop creating an electromagnetic field and will not heat the container bodies 4. Further, because the volume of air within the tunnels is relatively small (compared to prior art pin ovens), the ventilation system 84 may quickly evacuate air from the tunnel 42 to reduce the temperature of air in the tunnel to be below the curing temperature (if necessary). In some embodiments, the ventilation system 84 of the present disclosure is operable to completely vent air within the tunnel in less than 5 minutes, or less than 3 minutes, for example, when the pin chain stops. Optionally, the ventilation system 84 may evacuate air from the tunnel in less than 2 minutes. In some embodiments, the ventilation system may evacuate air from the tunnel in between about 1 minute and about 2 minutes.

Consequently, container bodies on the pin chain 66 within the oven will only be exposed to air below the curing temperature. During the time the conveyor system 58 and its pin chain 66 are stopped, the inks and coatings on the container bodies will not be heated excessively. Curing of the inks and coatings can be completed when the conveyor system 58 is activated at which time the power source 32 can begin supplying electricity to the induction element 36. Accordingly, decorations and coatings on the container bodies 4 within the oven 24 when the conveyor system 58 is stopped will not be damaged.

Moreover, air within the tunnel 42 can be vented at a rate sufficient to remove volatile organic compounds (VOCs) released by inks and/or coating on the container bodies as they are heated while permitting the air in the tunnel to be heated as the heated container bodies radiate heat.

The ventilation system 84 may also withdraw air from the tunnel 42 at a rate sufficient to maintain the tunnel at less than 1 atmosphere of pressure when the oven is in operation. This is beneficial to reduce the chance for VOCs to escape and migrate into the enclosed area 51 of the heater housing 34 or to the area defined by the frame 25.

In some embodiments, an interior of the oven is at a pressure greater than the pressure within the tunnel during operation of the oven. Additionally, or alternatively, in one or more embodiment, the interior of the oven is at an ambient pressure during operation of the oven, and the ventilation system maintains at least one tunnel at less than the ambient pressure during operation of the oven.

Additionally, or alternatively, air within a duct 88 associated with a heater housing 34 can be rapidly vented by the ventilation system 84. In this manner, the ventilation system 84 can quickly remove VOCs before the VOCs cool, condense, and drip onto the container bodies.

Optionally, only air in the oven 24 that is within a tunnel 42 is vented by the ventilation system 84. Accordingly, in embodiments, air within the oven that is not in a tunnel 42 is not vented or moved by the ventilation system 84. This is beneficial because reducing the volume of air moved by the ventilation system reduces the amount of power consumed by the ventilation system.

In contrast, in prior art ovens, hot air within the oven heats from the outside in: the hot air heats the ink or outer coating first and then the container body. It follows that air within a prior art oven must be at least equal to the curing temperature required to cure coatings on a container body. For example, some prior art ovens heat the air to between 390° F. to 425° F. or to an even higher temperature. The requirement to maintain air within a prior art oven at or above the curing temperature also limits the ability to vent VOCs from the oven. More specifically, if air within the prior art oven is vented too fast, the temperature of the air in the oven will fall below the curing temperature and the inks and coatings on the container bodies will not cure properly.

The ducts and venting within some prior art ovens take up a large amount of space, increasing the size of the oven and floor space required for the oven. Moreover, some prior art ovens include complex and costly heat exchangers to facilitate ventilation while attempting to maintain the temperature of air within the oven at or above the curing temperature. These features of ventilation systems of prior art ovens also increase the complexity and decrease the reliability of the prior art pin ovens. The ventilation systems also create noise and increase energy consumed by the ovens.

In some embodiments, the container bodies 4 enter the oven 24 at ambient (or room) temperature, for example between about 60° F. and about 80° F. In embodiments, the induction element 36 can heat the container body 4 from an initial temperature (such the ambient temperature) to a predetermined temperature, such as the curing temperature, in less than about 20 seconds. Optionally, the induction element 36 can heat the container body 4 to the predetermined temperature in from approximately 0.5 seconds to approximately 15 seconds. In some embodiments, the induction element 36 may heat the container body 4 to the predetermined temperature in from approximately 2 seconds to approximately 10 seconds. However, although an induction element 36 of the present disclosure may rapidly heat a container body, the rate of heating and the amount of heating must be carefully controlled. Overheating a container body can significantly reduce the work hardening of a container body and decrease the strength of the container body. Accordingly, when the container bodies 4 exit the oven, the container bodies are typically at a temperature of between about 285° F. and about 415° F.

In some embodiments, the induction element can heat a container body to approximately 400° F. in between approximately 0.4 seconds and approximately 5.5 seconds. For example, the induction element can heat the container body to approximately 400° F. in between approximately 0.4 seconds and approximately 0.8 seconds, or in approximately 0.6 seconds. Additionally, or alternatively, the induction element may heat the container body to approximately 400° F. in between approximately 4.5 seconds and approximately 5.5 seconds, or in approximately 4.9 seconds.

A sensor to determine the temperature of a container body 4 may be associated with the heater housing 34. In some embodiments, the sensor may be positioned in a tunnel 42.

Additionally, or alternatively, the sensor to determine the temperature of the container body 4 may be associated with the convenor system 58. For example, the sensor may be associated with a pin 70 of a pin chain 66.

In some embodiments, the sensor to determine the temperature of the container body is in communication with the control system 100 which receives temperature data from the sensor. Any suitable sensor known to those of skill in the art can be used to determine the temperature of the container body. In embodiments, the sensor can measure the temperature without contacting the container body 4. The sensor may be one or more of a pyrometer, an infrared thermometer, a laser thermometer, and an optical thermometer.

The oven 24 may optionally include a cooler 52 for the induction element 36. The cooler 52 is configured to keep the induction element from exceeding a set temperature.

In embodiments, the cooler 52 includes a hose or tube 54 associated with at least a portion of an inductor 38 of the induction element. The tube 54 is configured to hold a fluid in contact with the inductor 38. The fluid may be water or another suitable coolant.

Optionally, the tube 54 extends around an exterior surface of the induction element 36. In some embodiments, the tube 54 covers a substantial portion of the induction element.

Alternatively, in other embodiments, the tube 54 extends within at least a portion of the induction element. More specifically, in some embodiments, at least a portion of the induction element 36 is hollow (or includes a lumen). For example, in some embodiments, at least a portion of the induction element 36 is a hollow pipe. In this manner, the fluid of the cooler 52 may be circulated through at least a portion of (or all of) the induction element 36.

The cooler 52 may include a pump to circulate the fluid around the inductor. A thermometer (or any other suitable sensor) may be positioned to measure the temperature of the fluid. In embodiments, the control system 100 can send a signal to the pump to alter the rate of circulation of the fluid to maintain the temperature of the induction element below the set temperature. In some embodiments, the set temperature is about 150° F.

Additionally, or alternatively, the cooler is optionally configured to maintain the induction element 36 within an operating temperature during operation of the oven 24. Optionally, the operating temperature is between about 60° F. and about 115° F. In some embodiments, the cooler is configured to maintain the induction element at an operating temperature of between about 95° F. and about 105° F.

Optionally, the tunnel 42 is substantially continuous from a first heater housing 34A to a last heater housing 34L. For example, as generally illustrated in FIG. 4, optionally a tunnel extension 74 may be positioned between adjacent heater housings 34H, 34I. In this manner, warm air may be maintained within the tunnel 42 to facilitate capture of VOCs. Although only one tunnel extension 74 is illustrated in FIG. 4, in some embodiments a tunnel extension is positioned between all adjacent heater housings 34. Additionally, or alternatively, as generally shown in FIG. 6C, in some embodiments, a tunnel 42 may extend from the ends 40A, 40B of a heater housing 34. As mentioned herein, in some embodiments, the oven 24 may have only one tunnel 42 which extends through two or more heater housings 34.

In embodiments, the ventilation system 84 only removes air from the tunnel 42. More specifically, air within the oven 24 that is not in the tunnel is not moved by the ventilation system. Accordingly, the volume of air moved by the ventilation system 84 is less than for a prior art pin oven of a similar capacity. Moreover, in some embodiments, the oven 24 of the present disclosure requires less ducting and fewer fans or blowers than the prior art pin oven with the similar capacity.

In some embodiments, one heater housing 34 is used to heat the container body 4 to the curing temperature. Alternatively, and referring again to FIG. 4, the oven optionally includes two or more heater housings 34 configured to heat the container body 4 gradually or incrementally to the curing temperature.

The heater housings 34 are positioned sequentially along the pin chain 66 of the conveyor system 58. For example, a first heater housing 34A is positioned upstream to a second heater housing 34B and, optionally, to a third heater housing 34C. The heater housings 34 are configured to heat the container bodies in steps up to the curing temperature. Although twelve heater housings 34A-34L are shown in FIG. 4, the oven 24 may include any number of induction elements. In embodiments, the oven 24 of the present disclosure has from 1 to 20 heater housings 34.

Optionally, each induction element is associated with a separate power source 32. In embodiments, the control system 100 can send signals to the power sources 32 to adjust the electromagnetic field generated by each of the induction elements to alter the amount by which each induction element heats a container body. Additionally, or alternatively, the control system 100 can send a signal to adjust the duty cycle of an induction element 36. Optionally, the heater housings can have the same number of induction elements 36 (or inductors 38), or a different number of induction elements (or inductors).

The control system 100 can modulate the power provided to the heater housings 34A-34L (or more specifically, to their induction elements 36 or inductors 38) to adjust the rate of heating on the metallic container. In this way, the control system 100 can adjust the amount or rate of heating each induction element 36 provides without damaging the ink and/or coating on the metallic container.

In embodiments, the first heater housing 34A is configured to heat a container body 4 from an initial temperature to a first temperature. The initial temperature may be between approximately 60° F. and 120° F. In embodiments, the initial temperature is an ambient temperature, such as when the container enters the oven 24 through the entrance 28. The first temperature is optionally between approximately 130° F. and 180° F. Optionally, the first heater housing 34A can heat the container body to the first temperature in from approximately 1 millisecond to approximately 15 seconds.

The second heater housing 34B is configured to heat the container body from the first temperature to a second temperature that is higher than the first temperature. In embodiments, the second temperature is the curing temperature. Alternatively, the second temperature is less than the curing temperature. In embodiments, the second temperature is between approximately 180° F. and 280° F. The second heater housing 34B is configured to heat the container body to the second temperature in from approximately 1 millisecond to approximately 15 seconds.

Optionally, the third heater housing 34C is operable to heat the container body to a third temperature that is higher than the first and second temperatures. In embodiments, the third temperature is between approximately 280° F. and 400° F. The third temperature is optionally the curing temperature. Alternatively, the third temperature is less than the curing temperature. In embodiments, the third induction element 36C can heat the container body to the third temperature in from approximately 1 millisecond to approximately 15 seconds.

Referring again to FIG. 1, the container bodies 4 are removed from the conveyor system 58 after exiting the oven 24. In embodiments, a vacuum system (not illustrated) pulls the container bodies from the pin chain 66. Any suitable vacuum system known to one of skill in the art can be used with the oven and conveyor system of the present disclosure.

The oven 24 and heater housings 34 (including one or more induction elements 36) can cure any type of ink or coating on a container body. More specifically, the oven 24 can cure conventional inks and coatings. Additionally, the oven 24 of the present disclosure can be used to cure inks and coatings developed to be cured by an induction element 36.

In embodiments, the control system 100 can adjust operation of the heater housings 34 based on the type of ink or coating on the container body, the material of the container body (such as the type of metallic material and the mass of the container body), and a rate of movement of the pin chain 66 (and the container body) relative to the heater housings 34 within a tunnel 42. For example, depending on the type of ink or coating, the control system 100 can send a signal to one or more of the power sources 32 to adjust one or more of the rate of heating of a heater housing 34 and the maximum temperature to which the heater housing will heat a container body. Further, the control system 100 can adjust operation of a heater housing 34 based on a rate of movement of the pin chain 66. For example, in embodiments, the control system 100 will send a stop signal to a power source 32 to turn off a heater housing 34 (including an induction element 36) when the conveyor system 58 stops or the pin chain 66 slows below a set rate. In this manner, damage to mobility enhancers, inks and coating on a container body proximate to a heater housing 34 will not result from excessive heating.

In some embodiments, the control system 100 can send a signal to the power source 32 to alter the rate of heating of a container body based on the rate of movement of the pin chain 66. For example, if the pin chain 66 is moving at a first velocity past a heater housing 34, the control system can send a first signal to the power source 32 which causes the heater housing to heat the container body at a first rate. Moreover, if the pin chain 66 is moving at a second velocity relative to the heater housing, the control system can send a second signal to the power source that causes the heater housing to heat the container body at a second rate. In embodiments, the first velocity is greater than the second velocity and the first rate of heating is greater than the second rate of heating. Alternatively, the first velocity is less than the second velocity and the first rate of heating is less than the second rate of heating.

In some embodiments, the heater housings 34 heat a container body faster than the hot air within a prior art oven. Due to the rapid heating provided by the heater housings 34, the container body 4 does not need to remain in the oven 24 of the present invention as long as for a prior art oven. Some prior art ovens require more than 22 seconds to heat a container body to the curing temperature. In embodiments, the oven 24 of the present disclosure can heat a container body to a curing temperature is less than approximately 11 seconds, or less than approximately 6 seconds. Consequently, the pin chain 66 can have a length that is shorter than the length of a pin chain of a prior art decorator with a similar capacity. In embodiments, the length of the pin chain of the present disclosure is less than one-half the length of a pin chain of a prior art oven with a similar capacity. Shortening the pin chain 66 saves money, reduces the volume of the oven 24 and floor space required for the oven, and decreases maintenance costs associated with servicing the pin chain.

The ventilation system 84 of the oven 24 optionally includes an exhaust handling element 86. Some air from the ventilation system is exhausted to maintain air in the oven 24 (or within the tunnel 42) below a predetermined humidity, vapor content, or temperature. The control system 100 may send a signal to a louver or a vent to alter a volume of air directed to the exhaust handling element 86. In some embodiments, the ventilation system may exhaust up to approximately 2,000 standard cubic feet per minute (scfm) of air to the exhaust handling element 86.

The exhaust handling element 86 may optionally comprise a regenerative thermal oxidizer (RTO) to reduce VOC emissions. The RTO may be configured to destroy VOCs through means of high temperature thermal oxidation. In this manner, the RTO can convert the VOCs (and other pollutants) to carbon dioxide and water vapor while recovering the thermal energy generated for reuse.

Additionally, or alternatively, the ventilation system 84 may optionally comprise an integrated catalytic oxidizer (ICO) or integrated thermal oxidizer (ITO). The ICO/ITO is fluidically coupled to the ventilation system and comprises an entry through which the exhaust air comprising VOCs is directed. The ICO/ITO comprises one or more of a heater and a catalyst. The catalyst receives heated air from the heater. The VOCs in the heated air react with the catalyst to produce a flow of reacted air.

In some embodiments, the reacted air is directed back to the oven 24 to beneficially heat air in the tunnel 42. For example, in at least one embodiment, the ICO/ITO may selectively direct at least some of the flow of reacted air through a vent 89 into the tunnel 42.

Optionally, the ventilation system 84 includes a humidity measuring device that sends data to the control system 100. The control system may adjust the volume of air directed to the exhaust handling element 86 to maintain the air in the enclosure at a predetermined moisture level or within a predefined moisture range.

In some embodiments, the ventilation system 84 is configured to maintain air in the tunnel 42 below the lower explosive level (LEL) which defines the lowest concentration of a gas or a vapor in air that is capable of producing a flash in the presence of an ignition source. Because the oven 24 does not burn fossil fuels, the oven does not include an ignition source typically found in prior art ovens. Accordingly, in embodiments, the ventilation system 84 may maintain air in the oven 24 (and the tunnel 42) of the present disclosure at between approximately 1% and approximately 30% below the LEL. In other embodiments, the ventilation system 84 can maintain air in the oven 24 at between approximately 1% and about 24% below the LEL. This is a higher dilution rate compared to prior art gas-fired ovens which typically maintain air at 25% or more below the LEL. Because of this, the ventilation systems 84 of the present disclosure may extract less air volume and consume less electricity than ventilation systems of prior art gas-fired ovens.

The control system 100 may send a signal to a louver or a vent of the ventilation system to alter a volume of air vented to the exhaust handling element 86. In some embodiments, the ventilation system 84 includes an air monitor, such a VOC measuring device that sends data to the control system 100. The control system may adjust the volume of air directed to the exhaust handling element 86 to maintain the VOCs in air in the tunnel below a predetermined level (such as below the LEL) or within a predefined range (such as between approximately 1% and about 24% below the LEL). In various embodiments, the exhaust handling element 86 comprises a thermal oxidizer. Air with VOCs may be vented to the thermal oxidizer for treatment.

Optionally, a temperature measuring device is positioned within the duct 88 to measure the temperature of air passing through the duct. The control system 100 can receive data from the temperature measuring device and alter the rate of a fan 85 of the ventilation system 84 to adjust the temperature of the air within the duct. The control system 100 can adjust the operation of the fan 85 of the ventilation system as necessary to keep the air temperature and/or humidity below a predetermined level or within a predetermined range.

In embodiments, the control system 100 can send a signal to a motor of the fan 85 to adjust the air temperature in the duct and prevent condensation from forming in the oven to prevent drips onto the container bodies.

The ventilation system 84 may include a humidity measuring device that sends data to the control system 100. The control system may adjust the volume of air directed to the exhaust handling element 86 to maintain the air in the enclosure at a predetermined moisture level or within a predefined moisture range.

In embodiments, the exhaust handling element 86 comprises a condenser. Moisture captured by the condenser may be cleaned and reused. For example, in embodiments, moisture from the condenser may be returned to a washer used to clean the container bodies.

The ventilation system 84 may optionally include vents, louvers, perforations, or nozzles 89 to regulate and direct the flow of air past the heater housings 34 and the container bodies, and/or within the tunnel 42. In embodiments, the control system may adjust a louver or a vent, close perforations, or adjust a nozzle 89 to alter airflow of the ventilation system 84.

The ventilation system 84 may include an air monitor 99, such a VOC measuring device, that sends data to the control system 100. The control system may adjust the volume of air directed to the exhaust handling element 86 to maintain the VOCs in air in the enclosure below a predetermined level (such as below the LEL) or within a predefined range (such as between approximately 1% and about 24% below the LEL). The air monitor 99 may include probes or sensors that measure the quantity of VOCs are various points of the ventilation system 84 (such as within its ducts 88), the tunnels 42, and within the oven 24.

In embodiments, the exhaust handling element 86 comprises a thermal oxidizer. Air with VOCs may be vented to the thermal oxidizer for treatment.

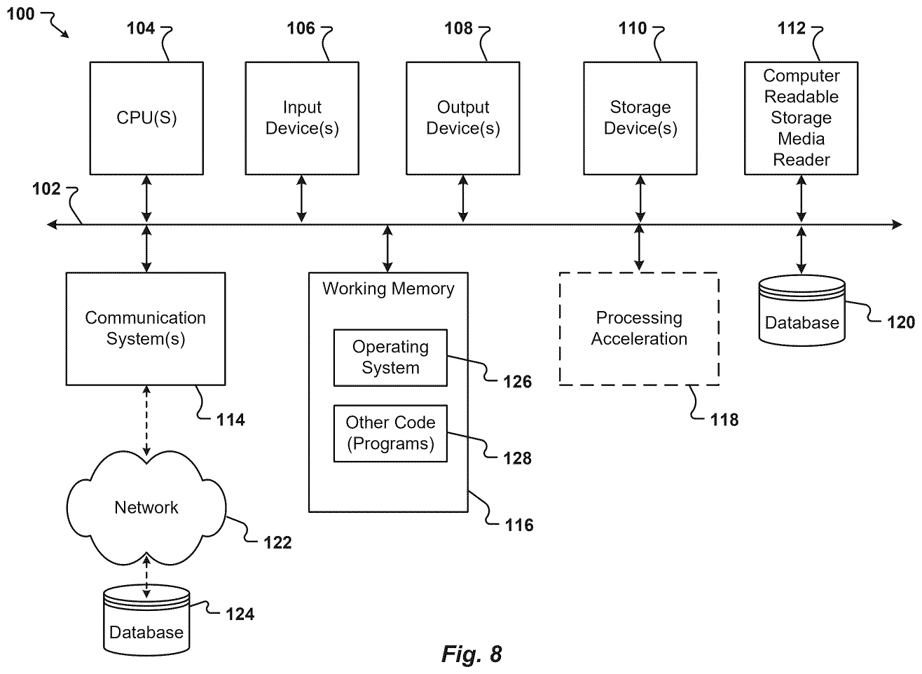

Referring now to FIG. 8, a control system 100 according to embodiments of the present disclosure is generally illustrated. More specifically, FIG. 8 illustrates embodiments of a control system 100 of the present disclosure operable to control elements of the oven 24 of the present disclosure. The control system 100 is generally illustrated with hardware elements that may be electrically coupled via a bus 102. The hardware elements may include one or more central processing units (CPUs) 104; one or more input devices 106 (e.g., a mouse, a keyboard, etc.); and one or more output devices 108 (e.g., a display device, a printer, etc.). The control system 100 may also include one or more storage devices 110. In embodiments, the storage device(s) 110 may be disk drives, optical storage devices, solid-state storage device such as a random access memory (“RAM”) and/or a read-only memory (“ROM”), which can be programmable, flash-updateable and/or the like.

The control system 100 may additionally include one or more of a computer-readable storage media reader 112; a communications system 114 (e.g., a modem, a network card (wireless or wired), an infra-red communication device, etc.); and working memory 116, which may include RAM and ROM devices as described above. In some embodiments, the control system 100 may also include a processing acceleration unit 118, which can include a DSP, a special-purpose processor and/or the like. Optionally, the control system 100 may also include a database 120.

The computer-readable storage media reader 112 can further be connected to a computer-readable storage medium, together (and, optionally, in combination with storage device(s) 110) comprehensively representing remote, local, fixed, and/or removable storage devices plus storage media for temporarily and/or more permanently containing computer-readable information. The communication system 114 may permit data to be exchanged with a network 122 and/or any other data-processing. Optionally, the control system 100 may access data stored in a remote storage device, such as database 124 by connection to the network 122. In embodiments, the network 122 may be the internet.

The control system 100 may also comprise software elements, shown as being currently located within the working memory 116. The software elements may include an operating system 126 and/or other code 128, such as program code implementing one or more methods and aspects of the present invention.

One of skill in the art will appreciate that alternate embodiments of the control system 100 may have numerous variations from that described above. For example, customized hardware might also be used and/or particular elements might be implemented in hardware, software (including portable software, such as applets), or both. Further, connection to other computing devices such as network input/output devices may be employed.

In embodiments, the control system 100 is a personal computer, such as, but not limited to, a personal computer running the MS Windows operating system. Optionally, the control system 100 can be a smart phone, a tablet computer, a laptop computer, and similar computing devices. In embodiments, the control system 100 is a data processing system which includes one or more of, but is not limited to: at least one input device (e.g. a keyboard, a mouse, or a touch-screen); an output device (e.g. a display, a speaker); a graphics card; a communication device (e.g. an Ethernet card or wireless communication device); permanent memory (such as a hard drive); temporary memory (for example, random access memory); computer instructions stored in the permanent memory and/or the temporary memory; and a processor. The control system 100 may be any programmable logic controller (PLC). One example of a suitable PLC is a Controllogix PLC produced by Rockwell Automation, Inc., although other PLCs are contemplated for use with embodiments of the present invention.

In embodiments, the control system 100 is in communication with one or more of the power sources 32 of the oven 24 of the present disclosure. Optionally, the control system 100 can send instructions to a power source 32 to adjust an amount or rate of heat provided by a heater housing 34 to a container body. Additionally, or alternatively, the control system 100 can adjust a duty cycle of a heater housing.

Additionally, or alternatively, the control system 100 can receive information from sensors of the oven. For example, the control system 100 can receive information from the cooler 52, temperature sensor, conveyor system 58, the motor of the conveyor system, the ventilation system 84, the fan 85, the temperature measuring devices, the humidity measuring devices, and the air monitor 99 (and its VOC measuring devices).

Referring now to FIG. 9, a container body 4 for a two-piece can 2 is generally illustrated. The container body 4 includes a closed end 14 with an optional dome 16, and a sidewall 6 with a cylindrical exterior surface 8 extending upwardly from the closed end. The container body has a hollow interior 10 and an interior surface 12 opposing the exterior surface 8. The body continues upwardly to an open end 18 opposite to the closed end. The container body 4 may have a neck 17 with a decreased diameter. The neck 17 may be formed before or after the container body 4 is heated by the oven 24. Other shapes and geometries of two-piece cans 2 can be supported by an endless loop (such as a pin chain 66) of the conveyor system 58 of the present disclosure.

Referring now to FIG. 10, a container body 4 for a metallic bottle 2 is illustrated. The bottle body 4 includes a closed end 14 with an inwardly oriented dome 16, a sidewall 6 with a cylindrical exterior surface 8 extending upwardly from the closed end, and a hollow interior 10 with an interior surface 12. The container body continues upward to a shoulder and a neck 17 with a reduced diameter. The neck 17 may be formed before or after the container body 4 is heated by one or more of the ovens 24. An open end 18 is positioned opposite to the closed end. Threads may subsequently be formed on the neck 17. Other shapes and geometries of metallic bottles 2 can be heated by the oven 24 of the present disclosure.

As will be appreciated by one of skill in the art, the oven 24 of the present disclosure can be applied or used in other manufacturing and decorating processes where heating or decorating of metal parts is required. For example, the oven 24 and heater housings 34 of the present disclosure can be used to dry metallic workpieces and to cure decorations and other coatings on any type of metallic workpiece including without limitation automotive parts, aircraft parts, metal castings, industrial equipment and tools, and the like.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

The term “automatic” and variations thereof, as used herein, refer to any process or operation done without material human input when the process or operation is performed. However, a process or operation can be automatic, even though performance of the process or operation uses material or immaterial human input, if the input is received before the performance of the process or operation. Human input is deemed to be material if such input influences how the process or operation will be performed. Human input that consents to the performance of the process or operation is not deemed to be “material.”

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

A “communication modality” can refer to any protocol or standard defined or specific communication session or interaction, such as Voice-Over-Internet-Protocol (“VOIP), cellular communications (e.g., IS-95, 1G, 2G, 3G, 3.5G, 4G, 4G/IMT-Advanced standards, 3GPP, WIMAX™, GSM, CDMA, CDMA2000, EDGE, 1×EVDO, iDEN, GPRS, HSPDA, TDMA, UMA, UMTS, ITU-R, and 5G), Bluetooth™, text or instant messaging (e.g., AIM, Blauk, eBuddy, Gadu-Gadu, IBM Lotus Sametime, ICQ, iMessage, IMVU, Lync, MXit, Paltalk, Skype, Tencent QQ, Windows Live Messenger™ or Microsoft Network (MSN) Messenger™, Wireclub, Xfire, and Yahoo! Messenger™), email, Twitter (e.g., tweeting), Digital Service Protocol (DSP), and the like.

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers to some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium,” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, read only memory (ROM), a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory.

The terms display and variations thereof, as used herein, may be used interchangeably and can be any panel and/or area of an output device that can display information to an operator or use. Displays may include, but are not limited to, one or more control panel(s), instrument housing(s), indicator(s), gauge(s), meter(s), light(s), computer(s), screen(s), display(s), heads-up display HUD unit(s), and graphical user interface(s).

The term “module” as used herein refers to any known or later developed hardware, software, firmware, artificial intelligence, fuzzy logic, or combination of hardware and software that can perform the functionality associated with that element.

The terms “determine,” “calculate,” and “compute,” and variations thereof, as used herein, are used interchangeably and include any type of methodology, process, mathematical operation, or technique.

While the exemplary aspects, embodiments, options, and/or configurations illustrated herein show the various components of the system collocated, certain components of the system can be located remotely, at distant portions of a distributed network, such as a local area network (LAN) and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a private branch exchange (PBX) and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In embodiments, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very-large-scale-integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or computer-generated imagery (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

To provide additional background, context, and to further satisfy the written description requirements of 35 U.S.C. § 112, the following references are incorporated by reference herein in their entireties: U.S. Pat. Nos. 3,894,237; 4,008,401; 4,297,583; 4,327,665; 4,535,549; 4,820,365; 5,218,178; 5,272,970; 5,323,485; 5,353,520; 5,821,504; 7,549,530; 8,959,793; 10,871,326; U.S. Patent Pub. 2006/0038313; U.S. Patent Pub. 2006/0127616; U.S. Patent Pub. 2007/0022624; U.S. Patent Pub. 2009/0176031; U.S. Patent Pub. 2012/0288638; U.S. Patent Pub. 2015/0360868; U.S. Patent Pub. 2019/302721; U.S. Patent Pub. 2020/0017305; U.S. Patent Pub. 2020/0080778; U.S. Patent Pub. 2020/0120757; U.S. Patent Pub. 2021/0071949; European Patent EP 0700503B1; European Patent Pub. 0715140A1; European Patent EP1572467B1; European Patent No. EP2437941B1; Great Britain Pub. 2,203,225; Japanese Patent JP 5925600B2; Japanese Patent Pub. JPS5425561A; PCT Pub. WO 2006/010141; PCT Pub. WO 2013/047917; PCT Pub. WO 2013/075877; PCT Pub. WO 2018/073095; and PCT Pub. WO 2020/051326.

What is claimed is:

1. An oven for curing a coating on an exterior surface of a metallic container body, comprising:
a heater housing, comprising:
a first end; and
a second end spaced from the first end;
a tunnel extending through the heater housing from the first end to the second end of the heater housing, the tunnel comprising:
an entrance at the first end;
an exit at the second end;
a wall extending from the first end to the second end, the wall defining a periphery of the tunnel, wherein the periphery has a geometry to receive the metallic container body; and
a slot extending through the wall, the slot extending from the entrance to the exit;
an induction element within the heater housing in an enclosed area between exterior surfaces of the heater housing and the periphery of the tunnel, the induction element operable to heat the metallic container body;
a pin chain extending through the oven, wherein a portion of the wall of the tunnel is positioned proximate to a portion of the pin chain with the pin chain positioned outside of the tunnel, and wherein the pin chain comprises a pin configured to engage an interior surface of the metallic container body, the pin extendable through the slot to transport the metallic container body through the tunnel, wherein the heater housing is configured such that the pin can transport the metallic container body through the tunnel during operation of the oven such that the exterior surface does not contact the tunnel; and
a ventilation system operable to selectively remove air from the tunnel.

2. The oven of claim 1, wherein the induction element comprises an inductor to create an electromagnetic field and produce an eddy current in the metallic container body.

3. The oven of claim 1, wherein the induction element comprises a cooling element to adjust a temperature of the induction element, and wherein the cooling element is configured to maintain the induction element within a predetermined operating temperature during operation of the oven.

4. The oven of claim 3, wherein the cooling element comprises one or more of:
a fluid; and
a tube that extends proximate to at least a portion of the induction element; and
a tube that extends through at least a portion of the induction element.

5. The oven of claim 1, wherein the heater housing is a first heater housing configured to heat the metallic container body to a first temperature, and wherein the tunnel extends through a second heater housing downstream from the first heater housing, the second heater housing comprising a second induction element configured to heat the metallic container body to a second temperature that is greater than the first temperature.

6. The oven of claim 1, wherein the ventilation system comprises a duct and a first port to draw air with contaminates from a first portion of the tunnel.

7. The oven of claim 6, wherein the ventilation system further comprises a second port to draw air with contaminates from a second portion of the tunnel, wherein the ventilation system can selectively withdraw air from:
only the first port;
only the second port; and
both the first and second ports.

8. The oven of claim 6, wherein the ventilation system further comprises a damper associated with the first port, the damper being adjustable from an open position to a closed position, and the damper being adjustable to a plurality of intermediate positions between the open and closed positions, wherein altering a position of the damper changes a volume of air removed from the tunnel through the first port.

9. The oven of claim 1, wherein the ventilation system is operable to maintain the tunnel at less than 1 atmosphere of pressure during operation of the oven.

10. The oven of claim 1, wherein the ventilation system comprises an exhaust fan.

11. The oven of claim 1, wherein a second portion of the wall is positioned between the induction element and an interior of the tunnel.

12. The oven of claim 1, wherein at least one portion of the wall is formed of a material that is one or more of non-magnetic, non-metallic, and heat resistant.

13. The oven of claim 1, further comprising a control system operable to send a signal to a power source associated with the induction element to adjust a heating output of the induction element.

14. The oven of claim 13, wherein the control system is operable to send the signal to the power source based on one or more of:
a velocity of the pin chain relative to the induction element;
a thermal conductivity of a metallic material of the metallic container body;
a predetermined rate of heating of the metallic container body;
a temperature to which the metallic container body will be heated; and
a type of the coating on the metallic container body.

15. A method of curing a coating on an exterior surface of a metallic container body, comprising:
positioning the metallic container body on a pin of a pin chain that extends through an oven;
operating the pin chain to move the metallic container body on the pin through a tunnel extending through a heater housing, the heater housing comprising:
a first end; and
a second end spaced from the first end;
the tunnel extending through the heater housing from the first end to the second end, the tunnel comprising:
an entrance at the first end;
an exit at the second end; and
a wall extending from the first end to the second end, the wall defining a periphery of the tunnel, wherein the periphery has a geometry to receive the metallic container body;
a slot extending through the wall, the slot extending from the entrance to the exit;
an enclosed area between exterior surfaces of the heater housing and the periphery of the tunnel, wherein a portion of the wall of the tunnel is positioned proximate to the pin chain with the pin chain positioned outside of the tunnel such that the pin extends through the slot to transport the metallic container body through the tunnel; and
an induction element within the enclosed area; and
providing electrical power to the induction element, wherein the induction element heats the metallic container body to a predetermined temperature.

16. The method of claim 15, further comprising sending a signal from a control system to a power source associated with the induction element to adjust a heating output of the induction element.

17. The method of claim 16, wherein the control system is operable to send the signal based on one or more of:
a velocity of the pin chain relative to the induction element;
a thermal conductivity of a metallic material of the metallic container body;
a predetermined rate of heating of the metallic container body;
a temperature to which the metallic container body will be heated; and
a type of the coating on the metallic container body.

18. A heater housing for curing a coating on an exterior surface of a metallic container body transported through an oven on a pin of a pin chain, comprising:
a first end;
a second end spaced from the first end;
a tunnel extending through the heater housing from the first end to the second end, the tunnel comprising a wall defining a periphery of the tunnel, wherein the periphery has a geometry to receive the metallic container body;
a slot extending through the wall to the tunnel, the slot extending from the first end to the second end, wherein a width of the slot is greater than a diameter of the pin such that the pin can extend through the slot to transport the metallic container body through the tunnel when the oven is in operation;
an enclosed area between exterior surfaces of the heater housing and the tunnel; and
an induction element within the enclosed area of the heater housing, the induction element operable to heat the metallic container body.

19. The heater housing of claim 18, wherein a portion of the wall is positioned between the induction element and an interior of the tunnel, and wherein the wall of the tunnel comprises:
a first wall portion;
a second wall portion opposite to the first wall portion;
a third wall portion extending from the first wall portion to the second wall portion; and
a fourth wall portion opposite to the third wall portion and extending at least partially between the first wall portion and the second wall portion, wherein the slot extends through the fourth wall portion.

20. The heater housing of claim 19, wherein one or more of the first wall portion, the second wall portion, and the third wall portion is formed of a material that is one or more of non-magnetic, non-metallic, and heat resistant.
